(19) United States
(12) Patent Application Publication
(10) Pub. No.: US 2025/0078051 A1
(43) Pub. Date: Mar. 6, 2025

(54) ASSET-BACKED TOKENS FOR INTERMEDIARY USE

(71) Applicant: EL-DAR AL-KHASSEH LTITWER AL-OMRANI Ltd., Jeddah (SA)

(72) Inventors: Essam Fakieh, Jeddah (SA); Ahmed A. Fadol, Washington, DC (US)

(21) Appl. No.: 18/809,223

(22) Filed: Aug. 19, 2024

Related U.S. Application Data
(60) Provisional application No. 63/535,886, filed on Aug. 31, 2023.

(51) Int. Cl. G06Q 20/06; G06Q 40/04; G06Q 50/163

(52) U.S. Cl. CPC G06Q 20/0655; G06Q 40/04; G06Q 50/163; G06Q 2220/12

(57) ABSTRACT

Described is a system configurable for receiving a first tangible asset ownership record from a custodian, and generating asset-backed digital tokens corresponding to the value of the tangible asset. The system receives a token disbursement from tangible asset procurers and transmitting the asset-backed digital tokens to virtual digital token storages of the tangible asset procurers. The system transmits all asset-backed digital tokens from the virtual digital token storages that hold the asset-backed digital tokens at a time of receiving the request to the virtual digital token storage of the tangible asset intermediary enabling usage rights of the tangible asset for the tangible asset intermediary. Periodically, the system receives token disbursements from an authorized user utilizing the tangible asset and distributing portions to various entities. The system transmits all asset-backed digital tokens back to virtual digital token storages, disabling usage rights of the tangible asset for the tangible asset intermediary.

### TECHNICAL FIELD

This patent application claims the benefit of U.S. Provisional Patent Application No. 63/535,886, filed Aug. 31, 2023, entitled “Asset-backed Tokens for Intermediary Use”, which is incorporated by reference herein in its entirety.

### TECHNICAL FIELD

The present disclosure relates generally to a tokenization system, and more specifically to tangible asset division and tokenization.

### BACKGROUND

Traditional home ownership often involves acquiring a mortgage from a financial institution like a bank or a mortgage lender. In this setup, an aspiring homeowner, upon finding a suitable property, applies for a mortgage loan. The lender evaluates the applicant's creditworthiness based on their financial history, current income, and debt levels, among other factors. If the application is approved, the lender provides the funds necessary to purchase the home, and the homebuyer agrees to repay the loan over a predefined period, typically in monthly installments over 15 to 30 years. The property serves as collateral, which means that if the borrower fails to make the required payments, the lender has the right to take possession of the home (foreclosure) and sell it to recover their funds. Over time, as the homebuyer makes their mortgage payments, they gradually build equity in the home, which represents their financial stake or ownership interest in the property. When the loan is fully repaid, the lender releases the lien to the deed, indicating full ownership to the home buyer.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 illustrates an architecture for tokenizing of a real estate asset, according to some examples.

FIG. 2 illustrates an architecture comparing conventional mortgage and rental systems with the tokenization system regarding ownership of the property over time, according to some examples.

FIG. 3 illustrates an architectural diagram between the tokenization system, asset owners, and individuals, according to some examples.

FIG. 4 illustrates an example method for intermediary users of asset-backed tokens of tangible assets, according to some examples.

FIG. 5 illustrates an architectural diagram of tokenized returns, according to some examples.

FIG. 6 illustrates how an intermediary acquires all tokens into the intermediary's virtual digital token storage and leases the home to an authorized user, according to some examples.

FIG. 7 illustrates an intermediary submitting tokens for use of a home, according to some examples.

FIG. 8 illustrates an intermediary obtaining access to land, such as farm land, according to some examples.

FIG. 9 is a diagrammatic representation of a machine in the form of a computer system within which a set of instructions may be executed to cause the machine to perform any one or more of the methodologies discussed herein, according to some examples.

FIG. 10 is a block diagram showing a software architecture within which examples may be implemented.

FIG. 11 illustrates a machine-learning pipeline, according to some examples.

FIG. 12 illustrates training and use of a machine-learning program, according to some examples.

FIG. 13 illustrates tokenization of an asset as a whole, according to some examples.

FIG. 14 illustrates tokenization of an asset that is divisible into parts, according to some examples.

FIG. 15 illustrates tokenizing ownership and/or usage across time, according to some examples.

FIG. 16 illustrate tokenizing ownership and/or usage across time and parts, according to some examples.

FIG. 17 illustrates tokenization for use allocations, according to some examples.

FIG. 18 illustrates token generation based on location, according to some examples.

FIG. 19 illustrates token generation for copies of goods, according to some examples.

### DETAILED DESCRIPTION

Traditional real estate assets tend to be illiquid. It can take months to sell a property or to find tenants for rental spaces. Liquidating other assets, like airline seats or car ownership, can be equally challenging in traditional systems.

Traditional real estate transactions involve several intermediaries such as brokers, banks, title companies, and others, all of whom typically charge fees, making the process more expensive and can introduce many errors along the way. Transfer of asset ownership in the traditional system can be cumbersome, requiring significant paperwork, background checks, and often, a lengthy period to close the deal.

Many high-value assets, like prime real estate or premium airline services, are out of reach for average investors. Traditional systems don't offer an easy way for small investors to participate in these investments or individuals to use such properties and services.

Moreover, traditional systems do not partition the usage rights of a traditional asset, like renting out just a portion of a house or only during certain times of the day using tokenization. This can lead to underutilization of assets. Payments, title transfers, and other processes also have a lag time due to the involvement of intermediaries and banks' working hours and days. Different intermediaries maintain records, such as banks, municipal offices, or title companies, leading to discrepancies and the need for reconciliation.

Information about an asset's history, past transactions, or the asset's genuine worth might be obfuscated in traditional systems, leading to asymmetric information and sometimes fraudulent practices. Moreover, traditional real estate investments often mean putting a substantial amount of capital into a single asset. This leads to a concentration of risk, such as by lenders.

Managing an asset, like collecting rent or ensuring optimal utilization, requires hands-on involvement or hiring of management firms in traditional systems.

Examples of the example tokenization system as described herein mitigate and/or eliminate the pitfalls of traditional systems as described above. The tokenization system described herein overcomes these challenges by offering a flexible, transparent, efficient, and cost-effective alternative to traditional real estate transactions and mortgage systems.

By tokenizing real-world assets, these tokens can be traded on secondary markets or exchanged platforms, offering real-time liquidity. Instead of waiting months to liquidate a real estate asset, token holders can sell their tokens to willing buyers almost instantly.

With tokenization, many intermediaries can be eliminated. Smart contracts on the blockchain can automate and streamline the processes involved in transferring asset ownership, significantly reducing both the time and cost. Additionally, the need for excessive paperwork and background checks can be minimized as all necessary information can be encoded onto the token itself.

Tokenization allows for fractional ownership and/or usage rights of high-value assets. This means that small investors can buy tokens representing a fraction of an asset, making previously unattainable assets accessible. Furthermore, individuals can also have the opportunity to use these properties and services by simply purchasing the required amount of tokens.

Tokenization allows for precise and customizable partitioning of usage rights. For example, if someone only wants to use a property during weekends, they can purchase tokens specifically for that timeframe. Similarly, tokenized assets on a blockchain enable almost instantaneous settlements, reducing lag times. Blockchain's decentralized ledger system ensures that all records are consistent across the network, negating the need for reconciliation between different record keepers.

Every transaction on the blockchain is transparent and immutable. This means that an asset's entire history is openly available and cannot be altered maliciously. Potential buyers can trace back every transaction related to the asset, reducing the chances of fraudulent practices. Additionally, because investors can purchase fractions of multiple assets, they can diversify their investments, reducing the risk associated with putting all their capital into one asset.

With tokenization, many operational aspects like rent collection or usage monitoring can be automated through smart contracts. Instead of needing constant hands-on management or hiring firms to handle assets, the system can generate many processes, ensuring assets are optimally utilized and revenues are correctly distributed among token holders.

When the effects in this disclosure are considered in aggregate, one or more of the methodologies described herein may improve known systems, providing additional functionality (such as, but not limited to, the functionality mentioned above), making such systems easier, faster, or more intuitive to operate, and/or obviating a need for certain efforts or resources that otherwise would be involved in the tokenization process. Computing resources used by one or more machines, databases, or networks may thus be more efficiently utilized or even reduced.

### Tokenization of Asset

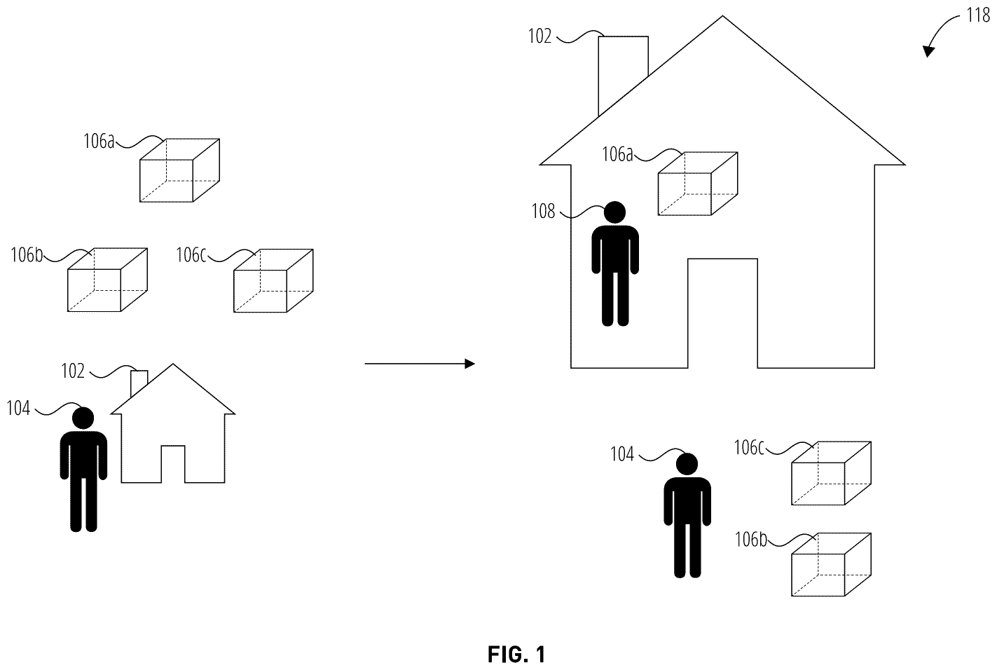

FIG. 1 illustrates an architecture 118 for tokenizing of a real estate asset, according to some examples. The process of tokenizing a home or an asset by the tokenization system can be described into several steps.

One step is for the tokenization system to evaluate the property to determine its current market value. In some cases, the tokenization system employs technological methods for estimating the value of a property. In some cases, the tokenization system compares the property to similar properties in the same area that have been sold recently by retrieving data from third party real estate databases.

In some cases, the tokenization system applies a regression analysis that can determine how different variables (like location, size, age, number of rooms, and nearby amenities) impact the property's value. The algorithm is trained on a vast dataset of property sales to learn the weight of each variable.

In some cases, the tokenization system applies Geographic Information System (GIS) data, which includes geographical and topological data about a property and its surroundings. The tokenization system applies this data to assess the value based on physical features like proximity to water bodies, hills, parks, and more.

In some cases, the tokenization system applies one or more artificial neural networks to predict property values. The neural network is trained on a large dataset and can handle complex, non-linear relationships between variables (such as data related to the property and other similar assets), making the estimate more accurate.

Although artificial intelligence, neural networks, and machine learning models are disclosed as performing certain features, it is appreciated that a machine learning model can be trained and applied by the tokenization system to perform any or all of the features of the tokenization system as described herein. For example, a first machine learning model facilitates decisioning by the tokenization system between modules and other machine learning models, whereas a second machine learning model generates a prediction of property values.

Systems and methods described herein include training a machine learning network, such as training to generate smart contracts, predict property values, mint tokens, facilitate transactions to various individuals and wallets, perform features on deeds and ownership, and/or the like. The machine learning network can be trained to perform one or more of the features for the tokenization system as described herein.

The machine learning algorithm can be trained using historical information. For example, the machine learning model is trained to generate smart contracts by applying historical real estate transactions for use cases on the tokenization system, resulting in self-executing smart contracts which are deployed on the blockchain (e.g., sent to the blockchain network and stored on the distributed ledger).

Training of models, such as artificial intelligence models, is necessarily rooted in computer technology, and improves modeling technology by using training data to train such models and thereafter applying the models to new inputs to make inferences on the new inputs. Here, the new inputs can be information relating to a new homeowner requesting tokenization of the home to rent and slowly selling the home to a new tenant. The trained machine learning model performs the various features of enabling the homeowner to tokenize the home and enable the new tenant to progressively own the home.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models.

Such training is the framework of machine learning algorithms that enable the models to be applied to new and unseen data (such as new tenant or asset owner data) and make predictions that the model was trained for based on the weights or scores that were adjusted during training. Such training of the machine learning models described herein reduces false positives and increases the model's performance.

Once the property value is established, the homeowner submits a digital version of the deed to the tokenization system. This deed serves as a legal proof of ownership and will be held by the tokenization system for the duration of the rental agreement.

Using the property's evaluated value and a particular value for each token (whether a predefined value or current market value), the tokenization system determines a number of tokens to be minted. For example, if a home 102 of FIG. 1 is valued at $300,000 and each token is worth $100,000, the system mints 3 asset-backed digital tokens 106a, 106b, 106c (collectively referred to herein as asset-backed digital tokens 106). These tokens are digital representations of ownership in the property.

The tokenization system mints new tokens on the blockchain or distributed ledger by creating new digital tokens or coins. First, the tokenization system generates a smart contract and the contract is deployed to the blockchain. This contract serves as the blueprint for the new tokens and contains rules about how the tokens can be transferred, how many will exist, and other necessary specifications.

Once the smart contract is live, the blockchain invokes the smart contract to mint new tokens. When the mint function is called, a specified number of tokens are created and assigned to the specified owner's address. In this case, an asset owner 104 is assigned as the owner of the asset-backed digital tokens 106 representing full ownership of the home 102. As the minted tokens are then awarded to the homeowner, the tokenization system effectively converts the tangible asset into a digital form of ownership that can be divided, sold, or traded.

Although the examples described herein explain blockchain technology, digital ledger technology, tokens, and/or smart contracts to apply to particular examples, it is appreciated that the features of the tokenization system can be applied to other blockchains, tokens, and/or smart contracts. For example, blockchain technology can be applied to predict property values, and mint tokens, whereas smart contracts can be applied to facilitate a transaction (such as a payment) to various individuals and wallets, perform features on deeds and ownership, and/or the like.

The advent of blockchain technology, tokenization, and/or smart contracts improve trusts in the tokenization system using various features rooted in technology. Blockchain technology ensures that once a transaction is recorded on the blockchain, it can't be changed. In the context of the tokenization system, once the owner receives tokens corresponding to their property's value, that transaction is recorded permanently. The same goes for each token that a tenant purchases. This creates a clear, immutable record of who owns the asset, making the system much more trustworthy.

Moreover, every transaction on the blockchain is visible to all network participants. This means that the process of tokenization, as well as each subsequent token purchase, is completely transparent. No one can secretly change the number of tokens or alter the value of the asset, because such a change would be visible to everyone on the network.

The decentralized nature of blockchain also contributes to its trustworthiness. Rather than relying on a single entity (like a bank or government) to verify transactions, blockchain uses a network of nodes (computers). Each node has a copy of the blockchain, and transactions are verified through a consensus process. In essence, multiple parties agree on the validity of transactions, making it virtually impossible for fraudulent activity to occur.

The tokenization system can use smart contracts to facilitate one or more processes of the tokenization system. The tokenization system writes (or a machine learning model automatically generates) smart contracts to automatically perform features of the tokenization system as described herein, such as transferring tokens from the tenant to the owner upon receipt of a transaction (such as a payment), and transferring ownership of the asset once all tokens have been purchased. Smart contracts execute automatically when certain conditions are met, and because they're also stored on the blockchain, they're transparent, immutable, and verifiable.

Tokenization of asset ownership, such as in the case of real estate, provides enhanced security and privacy in several ways. With the blockchain or similar decentralized technology that underlies tokenization, there's no central authority holding all the data. This makes it harder for cybercriminals to exploit a single point of failure.

Moreover, once a transaction is recorded and confirmed on the blockchain, it can't be altered or tampered with. This prevents any fraudulent changes to the ownership records. Every token can be tracked from its inception, offering a clear and indisputable lineage of ownership.

Blockchain uses strong cryptographic algorithms to ensure the data in the blockchain can only be read by those involved in the transaction. This means personal and financial data can be securely stored and transferred. The tokenization system applies cryptography to tokenize real estate or any asset on a blockchain. In some cases, the tokenization system applies a public-key (asymmetric) cryptography using pairs of keys: public keys (which may be known to others), and private keys (which are known only to the owner).

The generation of such keys depends on cryptographic algorithms based on mathematical problems to produce one-way functions. The owner of the private key can use the key to sign transactions or data, and anyone with the public key can verify the signature. In the context of blockchain tokenization, the ownership of tokens (and therefore the real estate) can be proven by the possession of the private key.

The tokenization system includes a hash function, which given an input, produces a fixed size string of bytes. Every transaction in a blockchain can be hashed and the hash value is stored in the block. Any change in the transaction data would change the hash, which can easily be checked. These hash functions ensure data integrity.

When a token owner wants to transfer their tokens (representing ownership or equity in a real estate property), the token owner can create a transaction and sign it with their private key. This digital signature proves that the transaction was created by the actual owner and was not tampered with. Anyone can verify the signature with the corresponding public key, but they cannot forge the signature without the private key.

In some cases, the tokenization system encrypts sensitive data using the public key which can only be decrypted using the corresponding private key. This means even if someone else gets hold of this encrypted data, they can't read or understand it without the private key.

These cryptographic features and algorithms of the tokenizing system underpin the security, trust, and immutability aspects of the asset-backed tokens that represent equity in the asset. Such use of keys improves data security by restricting unauthorized use, view, and/or recordation of data onto the tokenization system.

These keys are used to authenticate users to data (such as ownership) or transactions (such as a request to tokenize a tangible asset) which increases security, prevents unauthorized access by third parties, and enables users of the tokenization system to apply features in an easily implemented way. Moreover, such encryption features are necessarily rooted in computer technology.

With tokenization, personal details can be kept private while still proving ownership. Rather than sharing all of your personal information, a token representing ownership can be transferred while your personal data stays secured.

The tokenization system applies smart contracts which are self-executing contracts embedded with the terms of the agreement directly written into code and/or onto the distributed ledger. The smart contracts permit trusted transactions and agreements to be carried out among disparate parties without the need for a central authority, legal system, or external enforcement mechanism.

Traditional transactions typically involve intermediaries, such as banks or transaction processors, that have access to all transaction data. With blockchain technology, transactions are made directly between parties, which means that sensitive data, such as transaction information, isn't exposed to third-party companies. This reduces the risk of sensitive data being intercepted or misused.

In summary, through the use of blockchain and tokenization, you can create a secure, transparent system for real estate ownership and transactions that minimizes the risk of fraud, protects privacy, and enhances the security of sensitive data.

A tenant 108 rents the property and, in addition to paying rent, begins to purchase tokens from the homeowner. These transactions can be made separately or as part of the rent payment. Over the duration of the lease, the tenant can acquire one or more tokens, such as asset-backed digital tokens 106a, thereby gaining a portion of ownership in the property.

As the tenant begins to acquire tokens, the proceeds or dividends from the property are divided among the token holders based on their percentage of ownership. In the given example, if the tenant 108 has acquired one asset-backed digital token 106a, the tenant would receive ⅓ of the proceeds, while the homeowner would receive ⅔. The proceeds to the tenant can be less than ⅓ of the rent as the proceeds can be determined by subtracting expenses from the rent (such as insurance, property tax, property management). The homeowner could get more than ⅔ if the homeowner is the one performing property management.

This technical method of tokenization enables gradual transfer of ownership from the homeowner to the tenant and provides both parties with more flexibility and liquidity than traditional systems. It also allows for a more seamless and efficient real estate transaction process, reducing the need for intermediaries and reducing costs.

The tokenization system uses a combined order of specific procedures that tokenizes real world properties that represent ownership, and these tokens are used in a variety of different and novel ways as described herein. Not only do some examples and features of the tokenization system eliminate the need for intermediaries that are typical in the home purchasing process, the process of the tokenization system is also different than the process for traditional systems.

The tokenization does not simply automate traditional systems and concepts. By leveraging tokenization technology, the tokenization system enables efficiencies and improvements to the real estate world, such as by leasing of ownership and partial ownership, progressive ownership as a tenant using the property, deed recordation and ownership facilitation, other features of the ownership tokens, and/or the like.

### Conventional Mortgage and Rental Compared With Tokenization System Regarding Ownership Over Time

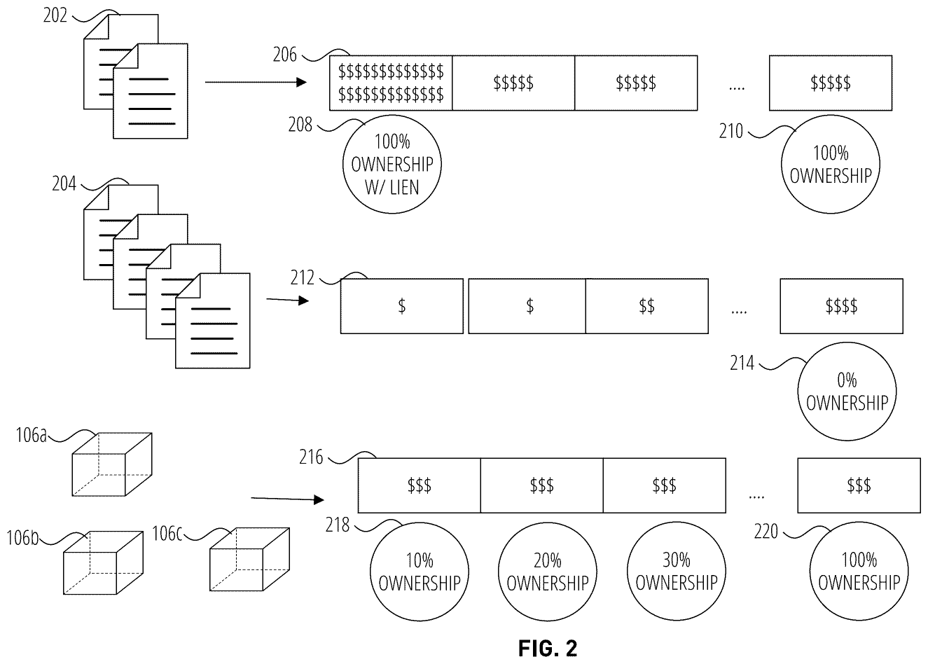

FIG. 2 illustrates an architecture comparing conventional mortgage and rental systems with the tokenization system regarding ownership of the property over time, according to some examples.

In a conventional mortgage system, the homebuyer typically pays a large down payment 206, often 20% of the home's value, and borrows the remaining 80% from a bank or other lending institution. The homebuyer gets legal 100% ownership of the property through a deed, but the lender also has a lien on the property (100% ownership with a lien 208), meaning they can foreclose and take possession if the homebuyer fails to make mortgage payments. The deed 202 is provided to the new buyer.

Integration with land record databases-The system could interface directly with public land records to submit lien documents for recording and retrieve confirmation. In some cases, the tokenization system implements self-executing smart contracts that automatically notifies relevant third party databases that have their own record (such as records of liens and ownerships), transfer lien-related assets, and/or record the lien on the blockchain upon meeting coded conditions.

In some cases, the tokenization system applies IoT sensors, such as sensors on deed documents could track their physical location and confirm when they are processed by the registrar's office. In some cases, the tokenization system applies computer vision algorithms, such as scanning deed documents and verifying registrar stamps and signatures using OCR and image analysis to validate recording (such as lien recording). In some cases, the tokenization system applies web scrapers to scrap public land record sites to check for lien recording and confirm registration details.

In some cases, the tokenization system applies Application Programming Interfaces (API) that interface with registrar's office databases, and submit via API lien data and retrieve recording confirmation of lien recordation programmatically. In some cases, the tokenization records the lien on a distributed ledger, such as recording the lien cryptographically on a blockchain to decentralized ledger.

Over the term of the loan, which could be 15 to 30 years, the homebuyer pays off the borrowed amount along with interest. The interest payments can significantly increase the total amount the homebuyer pays for the home. However, throughout this period, the homebuyer gradually gains equity in the home with each mortgage payment the homebuyer makes, and once the mortgage is fully paid, the homebuyer owns the home outright with 100% ownership 210 without a lien.

When a tenant rents a property, a contract 204 is signed between the tenant and the property owner that includes rental terms. The tenant pays a set amount 212 each month for the use of the property but gains no ownership or equity. Moreover, the rent could increase as time passes. This is typically the least costly option in the short term, as the tenant only pays for the use of the property and doesn't have to provide a large upfront down payment or pay interest. However, at the end of the lease, the tenant has 0% ownership 214 in the property, and all the money the tenant paid in rent does not contribute to any form of property ownership.

In contrast, the tokenization system combines elements of both mortgages and rentals while leveraging the advantages of tokenization technology. When the tenant uses this tokenization system, the tenant starts renting the property and also purchases asset-backed digital tokens 106 over time. Each token represents a fraction of ownership in the property. Each month, the tenant makes payments 216 for the rental of the property and also for the tokens. The tenant gradually builds equity in the property (such as 10% ownership 218 initially) without needing to provide a large down payment upfront or pay high amounts of interest to a lender. Over time, and as leases renew, the tenant accumulates enough tokens to own the property outright at 100% ownership 220 without any liens and risks of default. The tokenization system provides the flexibility to move without the need to sell property, given that the tokens can be sold, transferred, and/or held. The tenant also has the ability to acquire ownership over time, thereby making homeownership more accessible for more people.

### Architectural Diagram Between the Tokenization System, Asset Owners, and Individuals

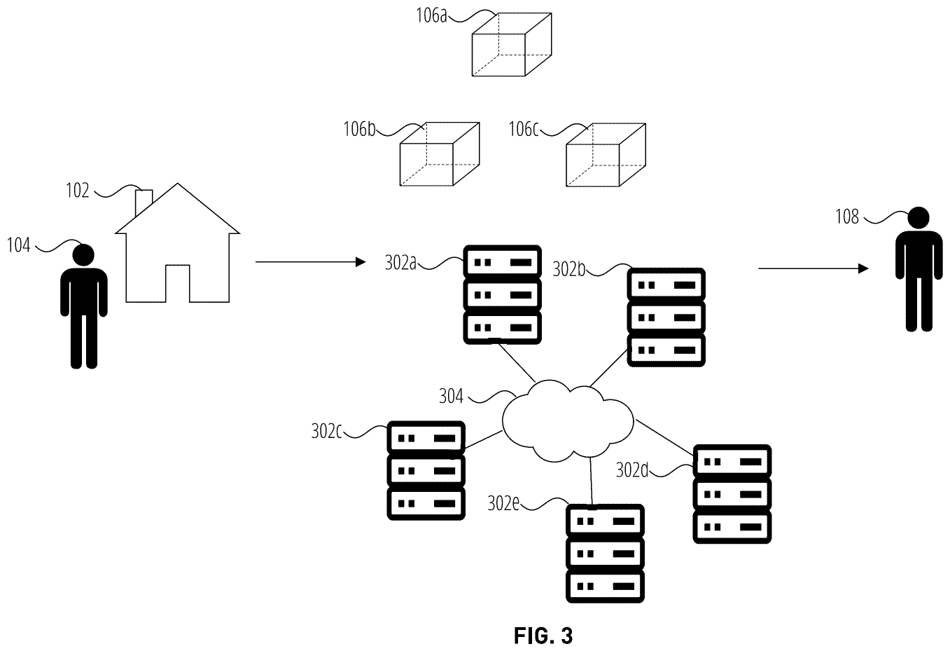

FIG. 3 illustrates an architectural diagram between the tokenization system, asset owners, and individuals, according to some examples. A group of computers 302a, 302b, 302c, 302d, and 302c (collectively referred to as the group of computers 302) connected to the Internet 304 runs the blockchain that forms a decentralized network, also known as nodes in blockchain terminology. These nodes are responsible for maintaining and updating the blockchain ledger, which in this case performs actions that record ownership, transactions, and contractual terms, and execute smart contracts for real estate properties.

When an asset owner 104 wants to tokenize their home 102, the asset owner submits the necessary documentation (such as a deed) to the tokenization system. The tokenization system receives a digital deed and performs functions using one or more forms of artificial intelligence, data processing, and cryptographic technologies.

The tokenization system receives a digital copy of the deed from the asset owner. This digital copy could be a scanned document or a photo of the physical deed. The tokenization system performs Optical Character Recognition (OCR), which can be a form of Artificial Intelligence (AI) that identifies text within digital images or scanned documents. The OCR module converts the visual representation of the text in the digital deed into machine-readable text.

Once the text has been recognized, a Natural Language Processing (NLP) module can be used to identify and extract key pieces of information. NLP, which can be another form of AI, is capable of understanding human language. In this case, the tokenization system identifies information such as the owner's name, the property description, boundaries, and any relevant legal language.

The extracted information is then standardized and stored in a structured database, enabling easy access and comparison. Standardization may involve transforming the text to conform to set formats, such as converting dates to a YYYY-MM-DD format, or geolocating addresses to standardized coordinates. Information, such as a digital copy of a deed, received from the various data sources can be of a different format.

In some cases, the machine learning model classifies the property based on the extracted information. The machine learning model identifies certain characteristics of the property that is not explicitly in the extracted information. For example, the machine learning model classifies a unit as a 1 bedroom based on its size and location.

The tokenization system configures data from multiple different databases that are in their own non-standardized format into a single standardized format. As such, messages can be automatically generated to communicate with individuals such as tenants and asset owners using the standardized format. Moreover, assessments and decisioning made by the tokenization system can be applied back to the asset owner by reapplying non-standardized formatting of the asset owner.

In some cases, the tokenization system processes the deed information into a viewable form, such as in a way which mirrors the physical representation of an original paper form of the deed. This reduces the time consuming nature of importing source code into the form. The tokenization system converts a digital copy of the deed into a standardized form which establishes calculations and rule conditions required to fill in the standardized form, import data from the digital copy to populate data fields in the standardized form, and performs calculations on the imported data. This allows the tokenization system to change imported data into a standardized viewable form.

In some cases, the tokenization system applies such standardization on documents or data received and/or documents generated. The tokenization system generates a standardized form of a deed to enable the tokenization system to generate a viewable deed form. In some cases, the tokenization system generates contracts, such as between the tenant and the asset owner, to rent and purchase tokens. The tokenization system collects data related to the tenant, asset owner, and asset from various different sources and applies standardization to this data to populate fields of the generated documents (e.g., contracts).

In some cases, the machine learning model performs one or more features of the standardization described herein. In some cases, the machine learning model performs customizations and/or standardizations based on a user's preferences. For example, the user inputs preferences such as a particular language for translation, customization on classifications and associated parameters, non-linear transformation, and/or the like.

In some cases, the tokenization system cross-checks information from the deed against a government or public property database. The tokenization system accesses such data via an API (Application Programming Interface) to interface with the relevant public records databases, query the extracted details, and compare the results for verification purposes. This step ensures that the property details match the official records and that the person claiming ownership is indeed the legal owner.

In some cases, the tokenization system and/or machine learning model cross-checks such information from the deed using other third party database. For example, the tokenization system checks information using global positioning system (GPS) data to verify the location, accesses photographs or data of prior owners such as on social media to verify the interior design of the home, and/or assesses a live camera feed from an augmented reality device. For example, the live camera feed can include a walk through of the property and the machine learning model applies computer vision algorithms to the camera feed to identify characteristics of the home, such as door types, bedroom locations, size, and/or the like.

Once the ownership is verified, the tokenization system divides the property's value into multiple tokens, as per the value evaluated by the system or provided by the user. The property can be divided based on a ratio of the value of the tangible asset and the value for each token. These tokens represent fractional ownership in the property. The token ownership records, deed, and other relevant details are encrypted and stored on a blockchain. Each token transfer can be managed via a smart contract, ensuring that all transactions are secure, transparent, and immutable, and the tokens are made available for tenants to purchase.

In some cases, the tokenization system applies the API to perform a recordation on the property records database, such as a records database of a government entity. In some cases, the tokenization system records a lien on the property based on tokens minted for the property.

In some cases, the tokenization system creates internal property records. For example, the tokenization system uses these internal property records for a layer of protection (e.g., to prevent multiple entries). In some cases, the tokenization system creates an internal property record to not have to rely on public records and/or to rely on such internal records when public records are unavailable.

If the tenant becomes the full owner, the tokenization system facilitates the transfer of ownership. The tokenization system initiates a transaction via the API with the property records database, to record the new ownership, such as via a smart contract indicating full ownership. These operations are conducted securely due to the cryptographic principles of the underlying blockchain and/or tokenization technology.

In some cases, the features related to the deed and/or other features of the tokenization system applies a self-referential table. A self-referential table includes a database table where a foreign key references the primary key of the same table. The tokenization system, for example, applies such self-referential tables to track the ownership history of the tokens representing asset ownership.

Each token could be represented as a row in the table, with fields such as token_id (the primary key), current_owner, previous_owner, and originating_asset (or depositor). The previous_owner field could reference another row in the same table, indicating the previous owner of the token before the current token owner, forming a chain of ownership. Such fields can be recorded onto the digital ledger. The tokenization system uses the originating_asset to associate a token with other tokens minted by the same asset owner. Advantageously, this field helps for certain features of the tokenization system, such as exchangeability and fungibility.

When a token is transferred from one owner to another (e.g., from the asset owner to a tenant), the current_owner field of the token's row is updated with the new owner's ID. A new row is also added to the table, representing a new token owner. The previous_owner field of this new row points to the row representing the token that was just transferred, creating a link in the chain of ownership.

Moreover, the tokenization system tracks a history of ownership via the self-referential table through the previous_owner field. Starting from a row representing a token's current owner, and previous_owner fields that would lead to the previous token owners before the current owner, and so on, until a row is reached where previous_owner is null, indicating the original token issued to the asset owner. This traceability adds to the transparency and security of the system, as it provides a tamper-proof log of token ownership changes.

When tokens are resold back to the asset owner or moved to another property, a similar process to the token transfer can be followed. The current_owner of the affected tokens is updated, and new rows are added to represent the new token owners.

The self-referential tables can include a special row and/or column within the database that stores the pointers to the other portions of the same table or other tables. Instead of having to save the benefit characteristics for each of the transactions or individuals, the tokenization system includes an entry that refers to another portion of the table or other table with the corresponding information. Advantageously, the data stored in each of the databases can be reduced by calling a call function (e.g. a database pointer) when a certain data entry in another table is needed.

Thus, a tokenization system and/or client devices can perform functions of the tokenization system and have more flexibility in assessing large datasets, which previously required a large network throughput of data and high processing speed. Moreover, a self-referential table can enable more efficient storage and retrieval of larger sized data, faster searching of the asset ownership, token distribution, and/or the like;, and more flexibility in configuring the database.

In some cases, the tokenization system includes the group of computers 302 and/or facilitates communication among the group of computers 302. The nodes in the network validate information, such as ownership, and if validated, the nodes initiate the token creation process. The value of the property is divided by the chosen token value to determine the number of tokens to be minted.

These asset-backed digital tokens 106, representing fractional ownership of the property, are issued to the asset owner (such as a tenant 108), such as to the asset owner's virtual asset storage. The transaction of minting and assigning these tokens is recorded on the ledger.

The nodes (such as the blockchain nodes) also manage the buying, selling, and leasing of tokens. For instance, when a tenant wants to buy tokens from an owner, the tenant submits a transaction to the network. The nodes verify the transaction, make sure the tenant has sufficient funds, and transfer the tokens from the owner's virtual asset storage to the tenant's. Once the transaction is validated and confirmed by the network (e.g., via the nodes), the transaction is recorded on the blockchain.

If a tenant accrues enough tokens to fully own the property, the blockchain network facilitates the transfer of ownership. The nodes of the blockchain burn or delete the tokens and update the property's ownership status on the digital ledger. The nodes validate this transaction before recording it on the blockchain. The nodes facilitate transfer over of the deed to the tenant.

When an asset owner (homeowner) decides to tokenize their property, the tokenization system evaluates the property to determine its current market value. The homeowner then provides the system with the necessary documentation (such as a copy of the deed) to confirm ownership of the property.

This information is verified by the decentralized network of computers running the blockchain, such as by accessing real estate records of ownership and/or on its own ledger of real estate ownership records. Once the information has been verified and the property's value has been established, the system will proceed with the tokenization process.

The value of the property is divided by the chosen token value (e.g., if a $300,000 property is divided into tokens each worth $100,000, 3 tokens will be minted as described above). These tokens, representing fractional ownership of the property, are digitally minted on the blockchain and assigned to the homeowner's virtual asset storage.

If a new tenant moves in or a lease is renewed, the system adjusts the valuation. if the value of the property increases, a certain number of additional tokens are minted and provided to the asset owner and/or the token holders associated with the property.

The homeowner may request to the tokenization system a re-evaluation of the property's value at any point, such as after significant improvements or renovations (e.g., adding a pool). If the value has changed, the system could initiate a re-tokenization process. For instance, if the property's value has increased from $300,000 to $500,000 and the token value remains at $100,000, two additional tokens would be minted and assigned to the homeowner and/or the token holders. This re-tokenization is recorded on the digital ledger.

Tokenizing real estate assets allows for flexibility in buying, selling, and transferring the tokenized assets. Individuals can trade tokens on a peer-to-peer basis on the tokenization platform, which is supported by the blockchain network. If a tenant wishes to buy tokens, they can send a transaction request to another individual who owns the tokens. The nodes verify ownership of the token and payment, and facilitate the transfer of ownership for the token.

The buyer sends the agreed upon amount (often in a form of cryptocurrency or any acceptable payment method on the platform) to the seller. Upon confirmation of payment, a smart contract is executed that transfers the tokens from the seller's virtual asset storage to the buyer's wallet. This transaction is recorded and verified on the blockchain, providing an immutable record and ensuring transparency.

In some cases, a buyer can buy or sell tokens directly from/to the asset owner. The asset owner lists the tokens for sale on the platform (such as with the specified price). A buyer who wishes to buy these tokens sends a purchase request, pays the specified price, and receives the tokens upon confirmation of payment via a smart contract. The smart contract ensures payment is made and tokens are owned and transferred. The asset owner can also buy back the tokens from the tenant or another token holder using a similar process.

Blockchain technology's inherent transparency, security, and immutability make it well-suited for this kind of application. Each node in the network independently verifies every transaction and maintains a copy of the ledger, making the system highly resilient and reliable. This decentralization also ensures that no single entity has control over the network, increasing trust and participation in the system using technological advances that are not typically used in real estate, let alone real estate ownership scenarios.

Intermediaries such as property developers or token aggregators could hold a pool of tokens from various properties and offer them for sale to interested buyers. The intermediary can list the tokens for sale on the platform, and buyers can purchase these tokens.

Intermediaries also can buy tokens. For instance, a token aggregator might be interested in buying tokens from various individual holders to add to their collection.

Individual token holders or asset owners could sell their tokens to these intermediaries following a similar transaction process as described herein.

In these scenarios, the use of smart contracts ensures that transactions are securely executed and recorded. The blockchain's decentralized nature ensures transparency, as all transactions are visible to all participants in the network.

In some cases, the tokenization system and/or a smart contract can facilitate the use of a property. For example, a tenant can be renting a home while obtaining tokens. The tokenization system can facilitate such use by sending a message to control the property. The tokenization system sends a wireless message to a lockbox on the property enabling the user to access keys to open the home. In some cases, such messages can control the use, type of use, availability of certain operations and features, time period and duration of use, and/or the like using these communications.

The tokenization system sends such signals to a computing device or server of the asset, such as a vehicle computing device or a server communicating with one or more smart home systems.

In some cases, depending on the rules set by the platform, tokens are used across properties, meaning a token holder could potentially use their tokens as payment to rent or purchase in another property on the platform. These features make the tokens of the tokenization system truly fungible and provide additional flexibility to the token holders.

In the context of tokenizing real estate, leasing tokens introduces a level of flexibility and unique opportunities for temporary ownership and use of assets. The tokenization system enables a token holder who owns a certain percentage of an asset to lease tokens to another individual. By doing so, the tokenization system enacts a smart contract that enables the other individual to gain temporary ownership of the tokens and, by extension, the right to use or benefit from a proportion of the asset represented by these tokens.

During the lease period, the tokenization system enables the temporary token holder to rent the property to a tenant. The proceeds from the tenant are received by the tokenization system, whereby smart contracts are invoked to provide the proceeds to the token holder and the temporary token owner. At the end of the lease, the tokenization system invokes a smart contract whereby the tokens are automatically returned to the token owner's wallet.

The distribution of rent proceeds automatically disperse via smart contracts. For instance, if the rent is paid in cryptocurrency, the smart contract automatically distributes the rent to the token owner, the temporary token owner, and property manager based on predefined percentages. For example, the property manager may require a certain amount or percentage of the proceeds.

Token leasing in this manner not only provides opportunities for passive income for token holders but also increases liquidity of the token in the token market. It further allows those without the capital to purchase tokens outright to benefit from tokenized assets temporarily.

Token holders in a real estate tokenization system have various investment strategies at their disposal. The token holders can engage in arbitrage, where they buy and sell tokens to take advantage of price discrepancies across different markets or platforms, turning a profit from the difference in token prices. This might occur if tokens representing the same asset are priced differently in distinct markets.

Token holders can adopt a long-term investment strategy, holding onto tokens to benefit from natural appreciation of the underlying real estate asset. In some cases, over time, as the property value increases, so does the value of each token, providing capital gains to the token holders. In some cases, new tokens are minted and distributed to each owner accordingly, such as if there are multiple owners to a property management company or to multiple properties. Token holders can also deposit or lease their tokens to others, earning a passive income. This approach allows others to use the tokens temporarily, such as for rental income, while the original token holder continues to derive financial benefit.

In some cases, the asset owner divides the value of a single asset (say, a house) into several tokens. Each token represents a proportional stake in the returns from the asset (like rent). The tokenization system enables transfer of property ownership to a token holder who accumulates tokens equivalent to the asset's total value. In such a case, the tokens corresponding to that asset are removed from circulation or “purged.”

In some cases, the tokenization system enables an asset owner to have several assets (say, multiple properties). Here, the total value of all assets is divided into tokens, each representing a proportional stake in the returns from all assets. Alternatively, each individual asset can also have its own token representation. The tokenization system enables token holders to acquire ownership of an individual asset or a percentage of a group of assets by accumulating tokens equivalent to the asset's total value. In some cases, different owners of the same or different properties can each tokenize their equity and/or ownership.

This kind of tokenized asset ownership provides investors with a new way to diversify their portfolios and potentially lower barriers to entry in markets like real estate using the technological advances of tokenization.

Although examples described herein refer to asset or real estate property, it is appreciated that examples described herein can refer to other types of assets, including both physical and/or intangible assets. For example, assets can refer to vehicles, such as cars, boats, planes, and other vehicles, allowing investors to own a piece of these assets and potentially share in their appreciation over time.

In some cases, the assets refer to artwork and/or collectibles, such as paintings, sculptures, rare collectibles, and other valuable items that can be tokenized to enable broader ownership. This could lower the barriers to entry in the art investment market, which has traditionally been accessible only to the wealthy.

In some cases, assets refer to intellectual property, such as copyrights, patents, and other forms of intellectual property. This could enable creators to raise funds while allowing investors to share in the potential profits from these assets.

In some cases, assets refer to commodities such as gold, oil, or agricultural products, providing another way for investors to gain exposure to these markets. In some cases, assets refer to business equity, allowing investors to buy and sell tokens representing shares in the company. In some cases, assets refer to debt instruments, such as bonds or loans, which could create more flexibility and liquidity in the debt market. In some cases, assets refer to digital assets such as domain names, digital art (such as non-fungible tokens-NFTs), and in-game assets.

### Intermediary Users of Asset-Backed Tokens of Tangible Assets

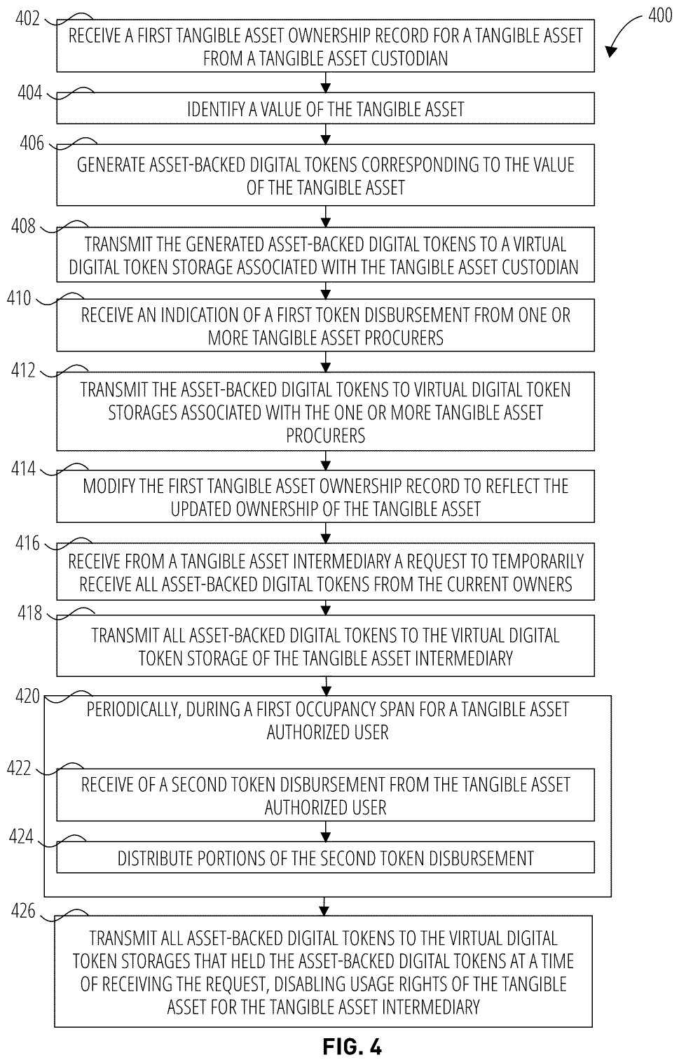

FIG. 4 illustrates an example method 400 for intermediary users of asset-backed tokens of tangible assets, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

At block 402, the tokenization system receives a first tangible asset ownership record for a tangible asset from a tangible asset custodian. The tokenization system acquires a digital representation of the legal rights associated with a tangible asset, provided by the individual or entity that currently holds those rights. The tangible asset can be any form of real-world property, such as real estate, vehicles, artwork, or other valuable goods.

In some cases, the tangible asset includes a real estate property, such as a home, a building, a car, equipment such as recording equipment, material such as gold or steel, technology such as a server or radio station, and/or the like. The tangible asset can include any real world object that can be divided based on its value, such as into tokens or asset-backed digital tokens.

The tangible asset ownership record includes a legal document that establishes the ownership and rights associated with the tangible asset. This could be a deed for a property, a title for a vehicle, or any other legal document that establishes ownership.

The process of digitizing this title involves taking a picture or scanning a physical copy of the tangible asset ownership record. The tokenization system converts the information within the tangible asset ownership record into a digital format that can be stored, transmitted, and processed electronically. In some cases, the tokenization system scans the tangible asset ownership record and applies optical character recognition (OCR) to extract text.

The tokenization system can apply a machine learning model to map data fields in the tangible asset ownership record to relevant data fields in the tokenization system database. In some cases, the tokenization system standardizes data in the tangible asset ownership record. For example, formats and data can be different across different documents, such as abbreviations, acronyms, and/or formats (e.g., zipcodes). The tokenization system standardizes such data, such as using a machine learning model, in order to store and process the data.

With data in standardized format, the tokenization system can compare data to other data in its database. If the tokenization system desires to send data back to the computing system that transmitted the tangible asset ownership record or other third party databases, the tokenization system converts the data into the non-standardized format of the receiving party.

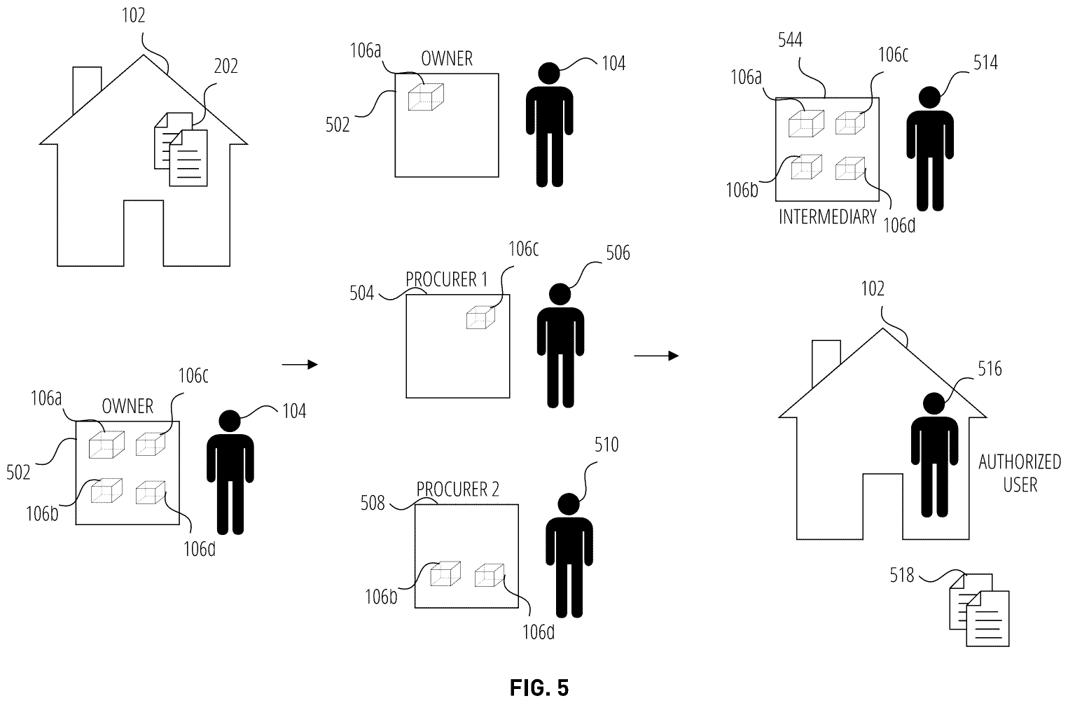

FIG. 5 illustrates an architectural diagram of tokenized returns, according to some examples. The tangible asset custodian 104 provides a tangible asset ownership record (such as a deed 202) to the tokenization system.

At block 404, the tokenization system identifies a value of the tangible asset. The tokenization system determines a monetary worth of the tangible asset. The tokenization system determines the value of the tangible asset through one or a variety of ways. In some cases, the tokenization system determines the value of the tangible asset depending on the type of tangible asset. For instance, in the case of real estate, the value could be determined through a professional appraisal system, comparative market analysis, or valuation models.

In some cases, the tokenization system applies a valuation model, such as a machine learning model. The tokenization system inputs one or more characteristics of the property. The tokenization system identifies such characteristics based on information from the tangible asset ownership record and/or third party databases. For example, the tokenization system can retrieve an address from the tangible asset ownership record and retrieve characteristics of the property, such as the number of bedrooms, square footage, and/or the like from third party databases.

In some cases, the tokenization system inputs characteristics of the tangible asset into the model, such as the condition, size, location, address, characteristics of the neighborhood, and other factors. The model is trained to identify similar assets (such as assets in a similar neighborhood that share certain characteristics of the tangible asset) and compares the property to these other similar assets that have recently sold in the same area to determine its estimated market value.

In some cases, the valuation models use mathematical modeling combined with databases of existing assets and transactions to calculate property values. These models can quickly provide an estimate of a property's value based on available data. This value serves as the basis for generating the asset-backed digital tokens that represent ownership of the tangible asset. This value is also used by the tokenization system, machine learning models, and/or smart contracts in accepting transactions if the value is within an acceptable range of values.

At block 406, the tokenization system generates a plurality of asset-backed digital tokens corresponding to the value of the tangible asset based on the value and a value for each asset-backed digital tokens. Each asset-backed digital tokens represents a fractional ownership interest in the tangible asset. For example, the tokenization system generates asset-backed digital tokens based on the market value and a value for each asset-backed digital tokens. Each asset-backed digital tokens represents a fractional ownership interest in the tangible asset.

The tokenization system creates (or mints) asset-backed digital tokens that represent fractional ownership in the tangible asset. These asset-backed digital tokens are generated in a quantity that corresponds to the previously determined value of the tangible asset.

The tokenization system identifies a value for each asset-backed digital tokens. The tokenization system can set the price of each asset-backed digital tokens. The price can be set by a user such as the tangible asset custodian, and/or the price can be set by the market (such as based on buy and sell orders on an exchange that exchanges asset-backed digital tokens for other monetary value such as money). The asset-backed digital tokens price can be a standard value across all physical assets, and/or it could vary based on factors such as the type of tangible asset, the total value of the tangible asset, or market conditions.

Once the value per asset-backed digital tokens is identified, the system determines the number of asset-backed digital tokens to be generated that corresponds to the value of the tangible asset. For example, the tokenization system divides the total value of the tangible asset by the value of each asset-backed digital tokens. For example, if a property is worth $100,000 and each asset-backed digital tokens is worth $100, the system would generate 1,000 asset-backed digital tokens. In another example, three asset-backed digital tokens, such as asset-backed digital tokens 106a, 106b, 106c, and 106d, are considered equal value to the home, and the asset-backed digital tokens 106 of FIG. 5 are generated by the tokenization system.

Each of these asset-backed digital tokens represents a fractional ownership interest in the tangible asset. For instance, in the above example, each asset-backed digital tokens would represent a 0.1% ownership interest in the property.

The tokenization system can initiate a distributed ledger and/or blockchain technology to generate the asset-backed digital tokens. The tokenization system initiates the blockchain to create unique, non-fungible asset-backed digital tokens that can be securely tracked and transferred. Each asset-backed digital tokens is a digital asset that is stored on the blockchain, providing a transparent and immutable record of ownership.

Once generated, these asset-backed digital tokens can be bought, sold, or traded, allowing for the fractionalization of ownership in the tangible asset. This enables individuals to invest in expensive physical assets such as real estate without needing to purchase the entire tangible asset outright or having to make a large down payment and sign onto a mortgage. The tokenization system also provides a mechanism for transferring ownership of the tangible asset over time, as individuals can gradually acquire asset-backed digital tokens until they own a majority or the entirety of the asset-backed digital tokens associated with the tangible asset.

At block 408, the tokenization system transmits the generated asset-backed digital tokens to a virtual digital token storage associated with the tangible asset custodian. A virtual digital token storage includes a software-based system that securely stores users' digital assets, such as cryptocurrencies and/or asset-backed asset-backed digital tokens.

The tokenization system initiates the transmission process once the asset-backed digital tokens have been generated. The tokenization system initiates a transaction on the blockchain network to move the tokens from the system's wallet (or a temporary holding wallet) to the tangible asset custodian's wallet.

The tokenization system initiates the creation of a digital signature using its private key, which is then broadcasted to the blockchain network. The network's nodes validate the transaction, ensuring that the tokenization system has the necessary balance of asset-backed digital tokens to perform the transaction and that the digital signature matches the system's public key.

Once validated, the transaction is added to a block of transactions, which is then added to the blockchain. This process ensures the immutability and transparency of the transaction, providing a clear record of the transfer of asset-backed digital tokens from the system to the tangible asset custodian.

The tangible asset custodian's virtual digital token storage will then update to reflect the receipt of the new asset-backed digital tokens. The tangible asset custodian then manages these asset-backed digital tokens within their wallet, including transferring them to other wallets or using them in transactions.

At block 410, the tokenization system receives an indication of a first token disbursement from one or more tangible asset procurers. The tangible asset owner (e.g. a homeowner) has tokenized their property using the tokenization system. This created a number of property tokens representing fractional ownership. These property tokens can be purchased by third party asset procurers interested in gaining fractional ownership in the property.

When an asset procurer wants to purchase tokens, they initiate the transaction through the tokenization system's token disbursement. In some cases, the asset procurer specifies key details such as the property address, number of tokens desired, price per token, total payment amount, etc, and submit this token purchase request to the system. The system receives this request and recognizes the request as an indication that an asset procurer desires to procure ownership of the property via a disbursement (such as of property tokens).

The system validates the asset procurer is an eligible buyer, the property is tokenized, and sufficient token supply is available. If validated successfully, the system initiates the token disbursement process by recording the transaction details to the blockchain ledger.

At block 412, the tokenization system transmits the asset-backed digital tokens corresponding to the first token disbursement from the virtual digital token storage associated with the tangible asset custodian to virtual digital token storages associated with the one or more tangible asset procurers reflecting updated ownership of the tangible asset.

The appropriate number of property tokens are transferred from the property owner's token wallet to the asset procurer's token wallet, with ownership records updated accordingly. In exchange, the asset procurer's payment is transferred to the property owner's account. The system records the completed disbursement of tokens from property owner to asset procurer, with both parties gaining fractional ownership per the token amounts transferred.

At block 414, the tokenization system modifies the first tangible asset ownership record to reflect the updated ownership of the tangible asset. The original property ownership record (such as a deed) includes the full legal description of the property and establishes sole ownership by the original property owner. When tokens are issued and sold, the deed must be updated to reflect the divided fractional ownership between the original owner and the new token holders.

To modify the deed, the tokenization system can electronically access the original digital deed record. The system can then programmatically edit the deed to add additional owner sections specifying the legal names and ownership percentages of the new token holders. For example, the modified deed could state the original owner 104 retains 25% ownership, the first asset procurer 506 has 25% ownership, and the second asset procurer 510 has 50% ownership. The virtual digital token storage 502 of the original owner 104 can store token 106a, the virtual digital token storage 504 of the first asset procurer 506 can store token 106c, the virtual digital token storage 508 of the third asset procurer 510 can store tokens 106b and 106d.

The system can insert these new sections into the existing deed document and update the totals accordingly. Cryptographic signatures and hashes can be appended to verify the authenticity and integrity of the modified deed. Alternatively, an entirely new deed can be generated which lays out the fractional ownership breakdown across all owners. The new deed retains the full property description but replaces the singular owner with the multiple owners and their percentages. This new deed can be digitally signed and recorded to supersede the previous version.

At block 416, the tokenization system receives from a tangible asset intermediary a request to temporarily receive all asset-backed digital tokens from the current owners of the tangible asset. After a property has been tokenized, with tokens sold to multiple owners resulting in fractionalized ownership, an intermediary may want to gain full access and rights to the property.

In some cases, the intermediary is an already fractional token owner. The intermediary can be a minority token holder or a majority token holder (e.g., holds the most tokens among the fractional owners, owns more than half of the value of the home, and/or the like. In some cases, intermediaries are any fractional token owner who owns at most (n-1) tokens of the asset, where the asset is valued at n tokens. The intermediary can lease the remaining tokens from other token owners in order to have full decision rights for the asset for a temporary amount of time.

The intermediary submits a request to the tokenization system to receive all outstanding property tokens. The system identifies the current ownership distribution of the property tokens across all existing token holders. The system initiates temporary token transfer requests to each of the current token owners.

At block 418, the tokenization system transmits all asset-backed digital tokens from the virtual digital token storages that hold the asset-backed digital tokens at a time of receiving the request to the virtual digital token storage of the tangible asset intermediary enabling usage rights of the tangible asset for the tangible asset intermediary.

The owners can approve transferring their tokens to the intermediary's temporary custody for a defined period of time. As the owners approve, their property tokens are transferred to and consolidated in the intermediary's token account. This grants the intermediary temporary ownership of all outstanding tokens.

With all tokens consolidated, the intermediary now has full access and usage rights to the property for the agreed period of time, while original owners temporarily forfeit their fractional rights. FIG. 5 illustrates an intermediary 514 collecting all outstanding tokens 106 into the virtual digital token storage 544 of the intermediary 514.

In some cases, the full access rights are decided by the parties owning the tokens and/or determined by the tokenization system. The full access of rights are determined before the tokens are leased by the intermediary. For example, full access rights can include, for t time period, if an individual is an intermediary holding all n tokens worth the value of the asset, the intermediary can use the property in certain ways as defined by the original asset owner upon minting the tokens. The original asset owner can define usage rights at the start, and/or the rights can be defined or modified over time.

With all outstanding property tokens consolidated into the intermediary's storage, the intermediary has temporary full ownership rights to the property. The intermediary can now lease the property to an authorized user 516 (such as a tenant) and collect rental income. The intermediary can negotiate lease contract 518 terms, rent amounts, and duration directly with prospective tenants, given their temporary full control.

In some cases, intermediary must have all n tokens for the asset in their possession to initiate having full temporary rights for a time period t. In some cases, if allowed by the asset owner, the current custodianship of the n tokens does not have to extend to the end of the period t. The intermediary can continue to acquire additional tokens (in order to maintain holding n tokens for the duration of the period t) as their previously held tokens are returned to their owners. This gives a high degree of flexibility in managing token borrowing to minimize total outlay for token renting fees. In some cases, original asset owner may not require full possession of n tokens by the intermediary to start the period of usage rights (as further described herein). In some cases, the tokenization system and/or the current token owners require a certain credit worthiness of the intermediary, such as via machine learning models or through third party data sources (as further described herein).

The intermediary can also utilize the property for other income generating activities during their temporary ownership. For example, they could operate it as a short-term vacation rental property and collect booking fees. The intermediary could market the property as an event venue and charge for its use. The intermediary has broad discretion on how to use the property.

At block 420, the tokenization system performs certain steps periodically, during a tangible asset utilization period for a tangible asset authorized user, such as blocks 422 and 424. At block 422, the tokenization system receives an indication of a second token disbursement from the tangible asset authorized user utilizing the tangible asset.

The tokenization system periodically receives signals or notifications of token disbursements from the tangible asset authorized user during a specified period of tangible asset use. The tangible asset authorized user could be a tenant, a renter, or any other party who is using the tangible asset but does not fully own it.

The tokenization system can receive token disbursements that can relate to one or more different actions related to the use or partial acquisition of the tangible asset. For instance, the tokenization system receives an indication of a rent payment, a purchase of additional asset-backed digital tokens representing ownership in the tangible asset, or the like. In some cases, the tokenization system determines such payment is made from a third party financial database or server. In other cases, the payment is made directly to the tokenization system.

The tokenization system receives the indication of the token disbursement via digital signal or message sent from the tangible asset authorized user's virtual digital token storage or account to the system. The indication includes information about the transaction, such as the amount paid, the number of asset-backed digital tokens purchased, and the time of the transaction.

The tokenization system receives this indication and processes it to update the records of the tangible asset and the associated asset-backed digital tokens. The tokenization system updates the balance of asset-backed digital tokens in the tangible asset authorized user's virtual digital token storage, updating the remaining value of the tangible asset, and/or updating the record of payments made by the tangible asset authorized user.

At block 424, the tokenization system distributes portions of the second token disbursement to the virtual digital token storage of the tangible asset intermediary, the one or more tangible asset procurers, and the tangible asset custodian.

In some cases, the portions are determined based on a number of asset-backed digital tokens in associated electronic token data repositories. For example, as shown in FIG. 5, the owner owned 25%, first procurer owned 25%, and the second procurer owned 50%. The intermediary may take a certain percentage, such as 20%, and the remaining amount divided among the shares owned prior to the intermediary collecting all tokens.

In some cases, another portion is allotted to costs, such as to property management, expenses, utilities, and/or the like. In some examples, a portion of the token disbursement is sent to the property manager. If the tangible asset custodian is the property manager, the tokenization system sends the portion of the token disbursement for rent and for property management to the tangible asset custodian. If the property manager is a third party, the tokenization system sends separate payments to the property manager and to the asset owner.

The tokenization system transfers the number of asset-backed digital tokens corresponding to the respective portions from the virtual digital token storage of the tangible asset authorized user to virtual digital token storages of the parties as described herein.

In some cases, the transfer process begins with the tokenization system initiating a transaction on the blockchain network. This transaction involves moving the specified number of asset-backed digital tokens from the tangible asset user's wallet to other users' wallets.

The tokenization system creates a digital signature for the transaction using the private key associated with the tangible asset user's wallet. This signature is then broadcasted to the blockchain network, where it is validated by the network's nodes. The nodes check that the tangible asset user's wallet has a sufficient balance of asset-backed digital tokens and that the digital signature matches the public key associated with the wallet.

Once validated, the transaction is added to a block of transactions, which is then added to the blockchain. This process ensures the immutability and transparency of the transaction, providing a clear record of the transfer of asset-backed digital tokens from the tangible asset user wallet to the other users' wallets.

In some cases, in response to a lapse of the tangible asset use period for the tangible asset authorized user, the tokenization system renews the tangible asset use period. In some cases, the tokenization system automatically renews the occupancy span. In other cases, the tokenization system generates a new contract to be agreed upon between the intermediary and the tenant for a new occupancy span. In some cases, the user period for the intermediary and/or the authorized user is assigned a specific period of time established by the asset owner, by the owners when the intermediary leased the tokens, and/or by the tokenization system. For example, the intermediary can be assigned full usage by the original asset owner for 7 years, but authorized users are under contract to use the asset one year at a time.

The tangible asset use period can include a predefined time period, such as a lease term or a use term, during which the tangible asset authorized user is expected to acquire full or partial usage rights, and full and/or partial ownership of the tangible asset by purchasing asset-backed digital tokens.

The tangible asset ownership record includes a digital version of a deed, title, or other legal document that establishes ownership of the tangible asset. This document is stored in a secure, tamper-proof format of the tokenization system, such as a blockchain or a secure database.

The tokenization system initiates the transfer of ownership (by procurers or intermediaries) by creating a transaction on the blockchain or updating the database to reflect the change in ownership. The tokenization system can change the owner field in the tangible asset ownership record to the identifier of the procurer or intermediary, or creating a new tangible asset ownership record with the procurer or intermediary as the owner (or temporary owner) and invalidating the previous document.

The tokenization system initiates broadcasting of the transaction or update to the network or commits the change to the database, where it is validated and recorded. This process ensures the immutability and transparency of the ownership transfer, providing a clear and indisputable record of the tangible asset procurer or intermediary's ownership.

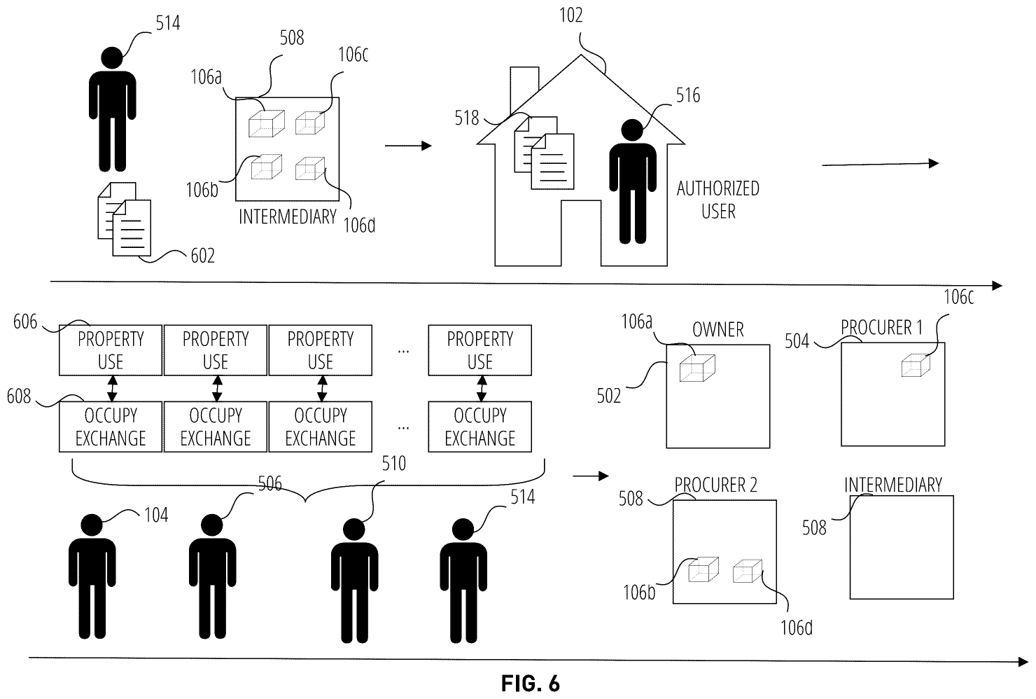

FIG. 6 illustrates how an intermediary 514 acquires all tokens 106 into the intermediary's virtual digital token storage 544 and leases the home 102 to an authorized user 516, according to some examples. The intermediary 514 then leases the home 102 to an authorized user 516. The intermediary can generate or the tokenization system can generate for the intermediary a lease contract 518 between the intermediary 514 and the authorized user 516. In some cases, the lease contract includes the intermediary, authorized user, and the owners of the home 102, such as the original owner 104 and the procurers.

In some cases, the tokenization system automatically enables access to the asset. For example, the tokenization system automatically configures digital locks or security systems. In some cases, the tokenization system generates a unique access code for the tangible asset authorized user upon receipt of the occupy exchange. The tokenization system sends the tangible asset authorized user this code, allowing them to access the property.

In some cases, the tokenization system uses smart contracts on the blockchain to automatically grant access rights to the tangible asset authorized user. The smart contract is programmed to change the status of the asset to ‘in use’ by the tangible asset authorized user upon receipt of the occupy exchange. Such a status initiates (and/or the smart contract initiates configuration of) proper technology, as described herein, to enable access to the property.

In some cases, the tokenization system configures Internet of Things (IoT) devices that are connected to the asset. The tokenization system sends commands to these devices to grant access to the tangible asset authorized user. For example, the tokenization system sends a command to unlock the doors of a rental property or to activate utilities of a car.

For assets such as rental assets or shared spaces, the tokenization system integrates with existing reservation platforms. Upon receipt of the use occupy exchange, the tokenization system automatically books the property for the tangible asset authorized user for the agreed-upon period.

In some cases, the tokenization system generates legal documents, such as lease agreements, that grant the tangible asset authorized user the right to use the property. In some cases, the tokenization system generates such documents by identifying relevant data fields and populating the fields with information retrieved. The tokenization system applies the standardized data (as described further herein) to the forms to generate legal documents for the parties to sign.

In some cases, the tokenization system applies a machine learning model to generate such legal documents. The machine learning model is trained to receive information related to the asset, the tangible asset custodian, and/or the tangible asset authorized user, and generate legal documents, based on training on historical asset, tangible asset custodian, and tangible asset authorized user data.

In some cases, the authorized user submits an occupy exchange 608, such as a rent payment, and in return, the tokenization system enables property use 606 of the home 102. Such occupy exchanges can be disbursed to various token storages of parties, such as of the original owner 104, the intermediary 514, or procurers 506 and 510.

At block 426, the tokenization system transmits all asset-backed digital tokens from the virtual digital token storage of the tangible asset intermediary to the virtual digital token storages that held the asset-backed digital tokens at a time of receiving the request, disabling usage rights of the tangible asset for the tangible asset intermediary.

The tokenization system records the tangible asset ownership record for the tangible asset from the intermediary to the prior owners, such as owner 104 and procurers 506 and 510.

In some cases, the tokenization system records or releases a lien on the deed when exchanges occur for the asset-backed digital tokens (such as to and from the intermediary). The tokenization system releases the lien such that the tangible asset custodian 104 and the procurer now owns the tangible asset free from the recorded lien upon return of the asset-backed tokens.

In some cases, upon termination of the property utilization, the tokenization system determines that the tangible asset authorized user has the option to continue the lease with the non-intermediary parties. In some cases, the authorized user was already using the asset before the intermediary collected the ownership tokens, and the intermediary facilitates management of the property and of the pre-existing authorized user.

In some cases, the intermediary is loaning the tokens from the owners, such that the tokens are automatically returned back to the owners after a certain time period. In some cases, the intermediary is purchasing the tokens from the owners with an option or a compulsory sale of the tokens back to the owners after a certain period of time.

At the end of the period, all leased tokens are programmatically transferred back to their original owners' accounts. The intermediary's temporary full ownership reverts back to the original distributed fractional ownership by the token holders. The tokenization system modifies or generates a new tangible asset ownership record reflecting the change of ownership.

In some cases, tokens are automatically transferred back once the token rental period is has been completed, according to contract between intermediary and token owner. The token rental or lease period by the intermediary can be different than the usage period for the authorized user. In some cases, the original asset owner establishes multiple period when the intermediary leases the tokens and/or the authorized user can use the property. The system processes the occupy exchange, the token purchases and/or loans, transfers of tokens and ownership, and/or the like by updating the blockchain or the database to reflect the new token ownership. This could involve the blockchain debiting the tenant's account for the amount of the occupy exchange and the token purchase, crediting the intermediary, procurer, and/or the tangible asset custodian's account for the property occupancy, debiting the tangible asset custodian's virtual digital token storage of one token, and crediting the tangible asset authorized user's virtual digital token storage of the one token, and/or the like.

In some cases, the tokenization system updates the digitized asset rights document, such as a deed or title, to reflect changes of ownership. The tokenization system creates a new digitized asset rights document with the owner's name and invalidating the previous document, or by updating the owner field in the existing document. The updated asset rights document is then recorded on the blockchain or in the database, providing a clear and indisputable record of the tangible asset's ownership.

In some cases, the tokenization system leaves the tokens in the virtual digital token storage of the owners after being transferred from the intermediary. In other cases, the tokenization system purges 812 the tokens from circulation. If the tokenization system keeps the tokens in the virtual digital token storage, the owners can use them to rent the asset to another tenant, effectively becoming the new tangible asset custodian. If the tokens are purged, the tokenization system removes the tokens from the tangible asset owners' virtual digital token storages and updates the blockchain or database to reflect the reduced supply of tokens. Advantageously, purging of the coins prevents the intermediary from selling the property using the tokens and/or selling the property separately using the asset ownership document.

Examples described herein are described according to one real world property. However, it is appreciated that the examples and features can apply to a collection of assets, such as a portfolio of assets owned by a developer or a real estate company. In this case, the “tangible asset” referred to herein include multiple individual assets, each of which could be a separate property. For example, the assets can be equivalent to a certain set amount of tokens. In other examples, the assets acquire tokens based on the value of the individual asset (e.g., the tokens are set to a particular price, and the tokens given to an individual asset is based on the number of tokens equivalent to the asset value).

The tangible asset custodian provides digitized asset rights documents for each property in the collection. The system identifies the total value of the collection of assets. The system generates asset-backed digital tokens corresponding to the total value of the collection of assets. Each token represents a fractional ownership interest in the entire collection, not just a single property. Thus, a tangible asset authorized user or intermediary who purchases tokens is gaining equity in the entire collection of assets, not just one property.

The tangible asset authorized user or intermediary is able to use one of the tangible assets in the collection, such as by renting a property. The system checks whether the quantity of tokens in the tangible asset authorized user or intermediary's virtual digital token storage equals or exceeds the number of tokens corresponding to the value of the collection of assets. If it does, the tokenization system transfers full ownership to the collection of assets to the tangible asset authorized user or intermediary. The system transfers the digitized asset rights documents for the entire collection of assets to the tangible asset authorized user or intermediary.

This approach allows a developer or real estate company to tokenize a portfolio of assets and sell fractional ownership interests to multiple tangible asset authorized users or intermediaries. It provides a flexible and efficient way for tangible asset authorized users or intermediaries to gain equity in a collection of assets, and it allows the tangible asset custodian to raise capital by selling tokens.

The system ensures proper ownership exchange by maintaining a clear and immutable record of all transactions related to the asset, including the initial tokenization of the asset and all subsequent transfers of tokens. This record serves as a digital chain of title, providing a transparent history of the asset's ownership.

When the tangible asset custodian first submits the digitized asset rights document (such as a deed) to the system, the system records this transaction on the blockchain or in a secure database. This initial record includes the tangible asset custodian's identity, the value of the asset, and the number of tokens generated.

Each time tokens are transferred from one virtual digital token storage to another, the system records the transaction. This includes transfers from the tangible asset custodian to the intermediaries or tangible asset authorized user (such as a tenant), as well as any subsequent transfers between different intermediaries or tangible asset authorized users. Each record includes the identities of the sender and receiver, the number of tokens transferred, and the time of the transfer.

The system maintains a complete record of all these transactions, creating a digital chain of title for the asset. This chain of title provides a clear and indisputable history of the gradual change in asset's ownership as well as the final transfer of full ownership.

By maintaining this digital chain of title, the system ensures that the ownership transfer is transparent, secure, and legally valid. The blockchain technology used in this process provides additional security by making the record immutable, meaning it cannot be altered or deleted once it's been recorded. This prevents fraud and disputes over ownership, providing peace of mind for all parties involved.

In some cases, the tokenization system applies a machine learning model that is trained to generate required documents for a particular property. For example, the machine learning model generates different documents for an apartment complex, a single family home, a commercial property, or for an automobile. In some cases, the machine learning model generates documents required for different jurisdictions, such as based on state law or documents needed for foreign jurisdictions.

In some cases, the tokenization system uses digital signatures to authenticate each transaction. Both the sender and receiver of tokens signs each transaction (such as with their private keys), providing a secure and verifiable record of the transaction.

In some cases, the system integrates online notary systems to notarize the transfer of ownership. This would provide an additional layer of legal assurance that the transfer is valid.

In some cases, the system automatically records, such as at a government agency database, a change of ownership. For example, the government agency database can hold a chain of title for a real estate property. The tokenization system initiates transmission of a message to the government agency database for the recordation of the new ownership to add to the chain of title.

In some cases, the system creates a new token recordation system that replaces and/or augments a centralized database, such as a government agency database. This can be useful if government agency databases are not complete and/or if no database currently exists.

In some cases, the tokenization system applies a machine learning model to optimize various aspects of the tokenization system. In some cases, the tokenization system applies historical data to the machine learning model, such as historical tangible asset ownership records, historical contracts between the intermediaries and user of the tangible asset, contracts between the intermediary and current owners, and/or the like and trains the model to generate an optimal token disbursement, such as an amount or value of the asset, and/or usage duration of the asset. The tokenization system uses the amount or value of the asset to verify a transaction as being within an acceptable range of the valuation.

The tokenization system trains a machine learning model using previous real estate contracts associated with different assets. Based on various factors such as property value, location, market conditions, historical trends, and more, the machine learning model is trained to estimate an optimal transaction amount and/or contract duration for a new property that's being tokenized.

For example, if the property is similar to previous assets, the machine learning model is trained from historical data to suggest terms based on an assessment of what happened for the previous assets. The machine learning model is trained to determine how quickly tokens were purchased for past property, any trends in token purchases, and so forth, to suggest a contract duration. Similarly, the machine learning model is trained to look at token prices in relation to the property value to suggest an optimal token price.

In some cases, the machine learning model is trained to perform one or more features of the tokenization system on assets that are non-similar. The machine learning model receives as input various characteristics of multiple assets, generate hidden latent variables across the different assets that factor into valuation, and applies such latent variables to compare assets that are dissimilar.

The tokenization system applies such models for the benefit of various entities. The tokenization system can help the tangible asset custodian in determining the parameters for their token offering. The tokenization system can help the tenant in evaluating different tokenization offers and finding the one that matches their financial capacity and goals. The tokenization system also applies such models to smart contracts to verify transaction by ensuring the values are within the range of values that the machine learning model estimates or outputs.

In some cases, the tokenization system trains a machine learning model by applying input lease agreements associated with different assets to determine the forecast expected total cost to a tenant for ownership and provide a comparison for different options.

The tokenization system trains a machine learning model to analyze past contracts and/or current market conditions to forecast a value a tenant could expect to submit over time to gain ownership of a property using the asset-backed digital tokens. The machine learning model is also trained to compare this total value against other options, such as compared to traditional home buying or other tokenized processes.

The tokenization system trains a machine learning model to use various inputs such as the property's token price, the length of the contract, market trends, and other relevant data. The model can process this information to generate a projection of total value to be submitted and uses this forecast to compare different home ownership options. The tokenization system helps tenants make informed decisions about the most cost-effective way to gain homeownership.

In some cases, the tokenization system trains a machine learning model to review a smart contract and translate the contract into a form aligned with certain tenant specified criteria. Smart contracts include self-executing contracts with the terms of the agreement directly written into code. The smart contracts detail the terms of the tokenization agreement, including token price, number of tokens, contract duration, and/or the like.

The machine learning model receives the smart contract code as input and translate the code into a format that aligns with the tenant's specific criteria or requirements, such as reinterpreting the terms into a more readable format, highlighting key terms and conditions, or mapping terms to specific criteria set by the tenant.

As such, the tokenization system applies such a machine learning model to help tenants to quickly understand the terms of various tokenization contracts, and how they align with their specific needs and goals. It would make the process of comparing and choosing between different tokenization options more accessible and user-friendly.

In some cases, the tokenization system applies a machine learning model that receives as input previous asset valuations and a new asset valuation report. The machine learning model is trained to determine a valid value range for the new asset. The tokenization system applies the value range as a parameter for confirming transaction validity by the distributed network of nodes. In some cases, the tokenization system enables the tangible asset custodian to apply such data to better calibrate asset tokenization parameters. In some cases, the tokenization system enables a potential token owner to apply such data to evaluate different token purchase options.

In some cases, the tokenization system applies a machine learning model to assist an asset owner in evaluating credit worthiness, credentials, and transactional records stored within system blockchain of the intermediary. Such assessment can be used by the original asset owner or by the tokenization system to determine characteristics of the agreement for the intermediary, such as a time period t to allow for usage rights, whether to allow for flexible management of tokens (e.g., current custody of tokens does not have to extend to end of period), whether to accept intermediary at all for lease of tokens, and/or the like.

In some cases, the tokenization system applies a machine learning model that generates assistance to the intermediary in manage their custodianship of tokens. For example, the machine learning model can be trained to minimize overall costs of token rental and provide metrics against such cost against token availability risk. The tokenization system enables tokens to be obtained in several ways, such as immediately from the open market, use derivatives to hedge supply, and/or the like.

Although the machine learning model is described to perform certain steps herein, it is appreciated that the machine learning model can facilitate and/or perform one or more features of the tokenization system, such as asset valuation, generation of tokens, transmitting of tokens from one wallet to another, providing usage to an asset user, and/or the like.

### Intermediary Submitting Tokens for use

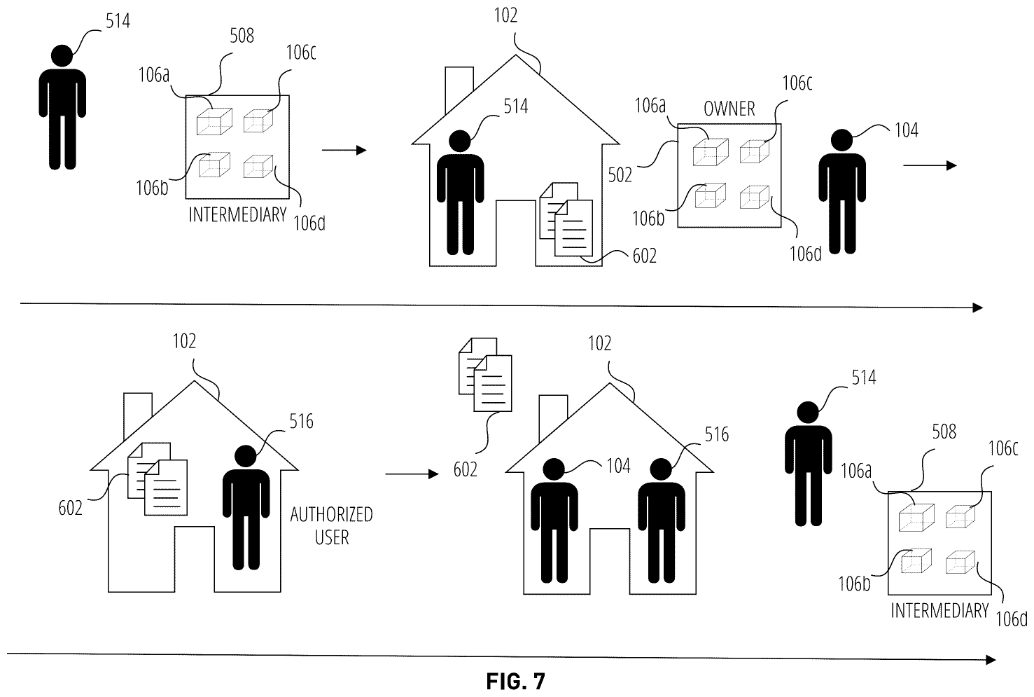

FIG. 7 illustrates an intermediary submitting tokens for use of a home, according to some examples. In some cases, an intermediary 514 purchases all outstanding tokens for a tokenized property from the current fractional owners of a home 102. In other cases, the intermediary purchases all tokens 106 that have a value equal to (or at least sufficient tokens for use of) the home 102 by transmitting the tokens into the intermediary's token storage 544. The intermediary now owns 100% of the tokens necessary for right to the property.

In some cases, the intermediary submits the tokens they own to the tokenization system as a deposit to access usage rights of the property for a set period of time. The tokenization system transfers the tokens from the intermediary to a holding account, granting the intermediary temporary usage rights. In some cases, the tokenization system sends the tokens to the token storage 502 of the home owner 104.

The intermediary and/or the tokenization system finds a tenant 516 and the intermediary and/or the tokenization system has the tenant sign a lease agreement 602 to rent the property. As the tenant pays rent, the tokenization system automatically disburses portions of the rent payment to the original property owners and the intermediary based on predefined percentages. For example, 80% of the rent could go to the owners and 20% to the intermediary.

At the end of the agreed usage period, all tokens are transferred from the holding account back to the intermediary. The property reverts fully to the original owners. If the tenant wishes to continue occupying the property, the tenant now pays rent directly to the owners as per a new lease agreement 602. The intermediary retains the income they made during the period they had usage rights.

### Farm Land as Asset

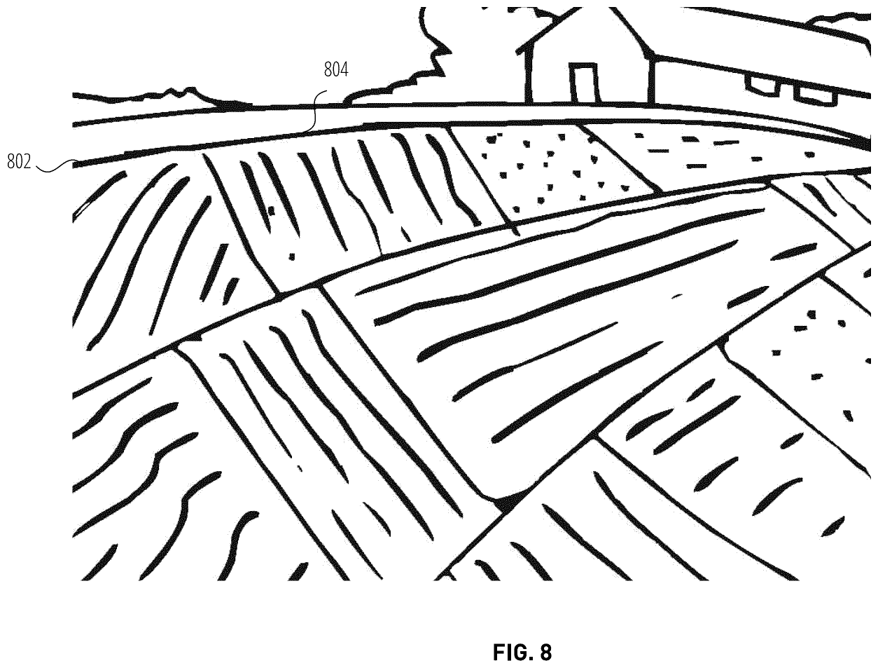

FIG. 8 illustrates an intermediary obtaining access to land, such as farm land, according to some examples. The farm land owner has tokenized their property, dividing it into tokens representing fractional ownership. This allows the land to be leased and used in portions rather than requiring a single owner.

The tokenization system identifies an intermediary that specializes in agriculture and finding farmers who wishes to lease the farm land. As an expert in the field, the intermediary can efficiently find suitable farmers to utilize the land.

In some cases, the tokenization system identifies one or more intermediaries that can be allotted different portions of the land. For example, the tokenization system identifies certain intermediaries for certain portions of the land. Even the tokenization system can identify multiple intermediaries even to a single portion of land across different time periods. One intermediary can be given usage rights for the land during the summer, whereas another intermediary given usage rights for the winter.

The farm owner approves transferring all outstanding farm land tokens to the intermediary for a defined lease period. The smart contracts on the blockchain facilitate the temporary transfer of the land tokens to the intermediary. The intermediary now has temporary rights to utilize the farm land. The intermediary can access, use, and/or sublease the land for the lease term. In some cases, the tokenization system enables use of the land to one or more intermediaries for entire period, or one or more intermediaries for distinct periods less than total period, and/or any combination thereof.

The tokenization system can identify a farmer who wishes to plant and harvest crops on the land. The tokenization system generates a contract between the intermediary and farmer outlining terms of use, duration, and payment. The smart contract system ensures the agreement is transparent and automatically enforced (as further described herein).

The farmer takes occupancy of the farm land and plants/grows crops. The farmer relies on the intermediary's temporary land rights to securely plant crops without ownership risk. At harvest time, the farmer retains a predefined portion of the crop yield as payment for their labor. The tokenization system applies smart contracts to automate the distribution of payment to the farmer based on the crop yield.

The remaining crop yield is sold, with proceeds going to the intermediary as the temporary land owner. The intermediary benefits from the income generated by the land during their lease term. The intermediary retains a percentage of the sales income as their fee. This incentivizes the intermediary to find good farmers and crops to maximize income.

The remainder of the income is distributed to the original farm land token holders as an “occupy exchange.” Even while leased, the land generates income for the actual owners. After the harvest, all tokens representing the farm land are returned to the original owners. The finite lease period enforced by smart contracts protects the original owners' long-term interests.

The land rights revert from the intermediary back to the fractional token holders. The owners regain usage and income rights after the intermediary's temporary lease expires.

In some cases, the intermediary can gain access to a parcel 804 of the farm land and/or the entire farm land 802. In some cases, the intermediary gains access to the entire farm land 802 and provides access to individual parcels, such as parcel 804, to individual farmers.

In some cases, the tokenization system applies a machine learning model trained to recommend one or more intermediaries for the asset owner. For example, the machine learning model identifies relevant intermediaries from empirical performance data of intermediaries stored on block chain transactions (from past engagements), external third party databases (e.g. certification authority or past performance metrics), responses (from sent request for proposals-RFPs), and/or the like.

In some cases, the tokenization system applies a machine learning model trained to convert asset owner requirements in a non-standard format to a standardized format to be sent to potential intermediaries. The tokenization system can translate the asset owner requirements into a non-standard format specific to intermediaries. Intermediary response can be converted to a standardized format, then to the non-standardized format of the asset owner such that the machine learning model can evaluate potential intermediaries and asset owners effectively.

### Machine Architecture

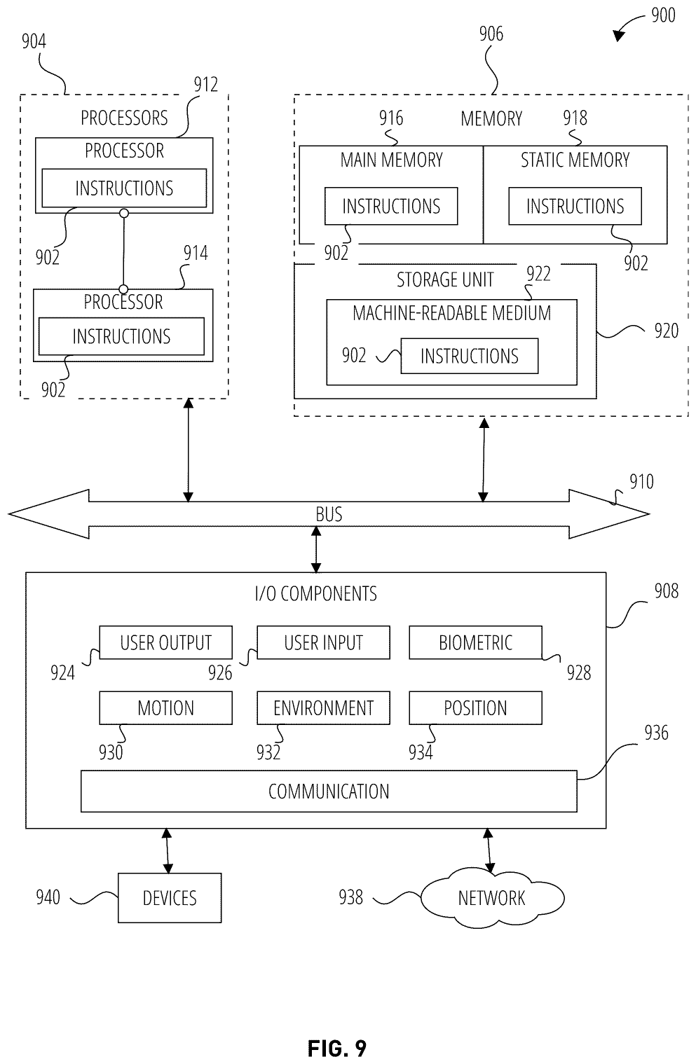

FIG. 9 is a diagrammatic representation of the machine 900 within which instructions 902 (e.g., software, a program, an application, an applet, an app, or other executable code) for causing the machine 900 to perform any one or more of the methodologies discussed herein may be executed. For example, the instructions 902 may cause the machine 900 to execute any one or more of the methods described herein. The instructions 902 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 902, sequentially or otherwise, that specify actions to be taken by the machine 900. Further, while a single machine 900 is illustrated, the term “machine” shall also be taken to include a collection of machines that individually or jointly execute the instructions 902 to perform any one or more of the methodologies discussed herein. The machine 900, for example, may comprise a user system or any one of multiple server devices forming part of the server system. In some examples, the machine 900 may also comprise both client and server systems, with certain operations of a particular method or algorithm being performed on the server-side and with certain operations of the particular method or algorithm being performed on the client-side.

The machine 900 may include processors 904, memory 906, and input/output (I/O) components 808, which may be configured to communicate with each other via a bus 910. In an example, the processors 904 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 912 and a processor 914 that execute the instructions 902. The term “processor” is intended to include multi-core processors that may comprise two or more independent processors (sometimes referred to as “cores”) that may execute instructions contemporaneously. Although FIG. 9 shows multiple processors 904, the machine 900 may include a single processor with a single-core, a single processor with multiple cores (e.g., a multi-core processor), multiple processors with a single core, multiple processors with multiples cores, or any combination thereof.

The memory 906 includes a main memory 916, a static memory 918, and a storage unit 920, both accessible to the processors 904 via the bus 910. The main memory 906, the static memory 918, and storage unit 920 store the instructions 902 embodying any one or more of the methodologies or functions described herein. The instructions 902 may also reside, completely or partially, within the main memory 916, within the static memory 918, within machine-readable medium 922 within the storage unit 920, within at least one of the processors 904 (e.g., within the processor's cache memory), or any suitable combination thereof, during execution thereof by the machine 900.

The I/O components 908 may include a wide variety of components to receive input, provide output, produce output, transmit information, exchange information, capture measurements, and so on. The specific I/O components 908 that are included in a particular machine will depend on the type of machine. For example, portable machines such as mobile phones may include a touch input device or other such input mechanisms, while a headless server machine will likely not include such a touch input device. It will be appreciated that the I/O components 908 may include many other components that are not shown in FIG. 9. In various examples, the I/O components 908 may include user output components 924 and user input components 926. The user output components 924 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 926 may include alphanumeric input components (e.g., a keyboard, a touch screen configured to receive alphanumeric input, video input (e.g., camera), peer-to-peer input (e.g., chatbot), a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 908 may include biometric components 928, motion components 930, environmental components 932, or position components 934, among a wide array of other components. The motion components 930 include acceleration sensor components (e.g., accelerometer), gravitation sensor components, rotation sensor components (e.g., gyroscope).

The environmental components 932 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

The position components 934 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 908 further include communication components 936 operable to couple the machine 900 to a network 938 or devices 940 via respective coupling or connections. For example, the communication components 936 may include a network interface component or another suitable device to interface with the network 938. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 940 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (e.g., main memory 916, static memory 918, and memory of the processors 904) and storage unit 920 may store one or more sets of instructions and data structures (e.g., software) embodying or used by any one or more of the methodologies or functions described herein. These instructions (e.g., the instructions 902), when executed by processors 904, cause various operations to implement the disclosed examples.

The instructions 902 may be transmitted or received over the network 938, using a transmission medium, via a network interface device (e.g., a network interface component included in the communication components 936) and using any one of several well-known transfer protocols (e.g., hypertext transfer protocol (HTTP)). Similarly, the instructions 902 may be transmitted or received using a transmission medium via a coupling (e.g., a peer-to-peer coupling) to the devices 940.

### Software Architecture

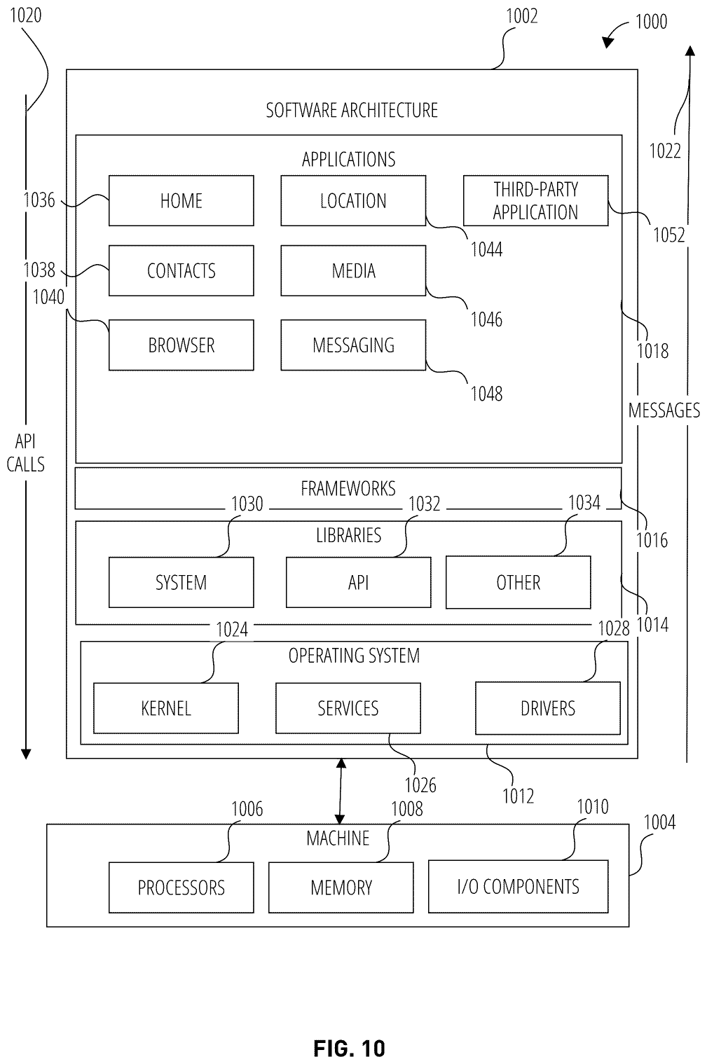

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematic functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various graphical user interface (GUI) functions, high-level resource management, and high-level location services. The frameworks 1016 can provide a broad spectrum of other APIs that can be used by the applications 1018, some of which may be specific to a particular operating system or platform.

In an example, the applications 1018 may include a home application 1036, a contacts application 1038, a browser application 1040, a location application 1044, a media application 1046, a messaging application 1048, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

### Machine-Learning Pipeline

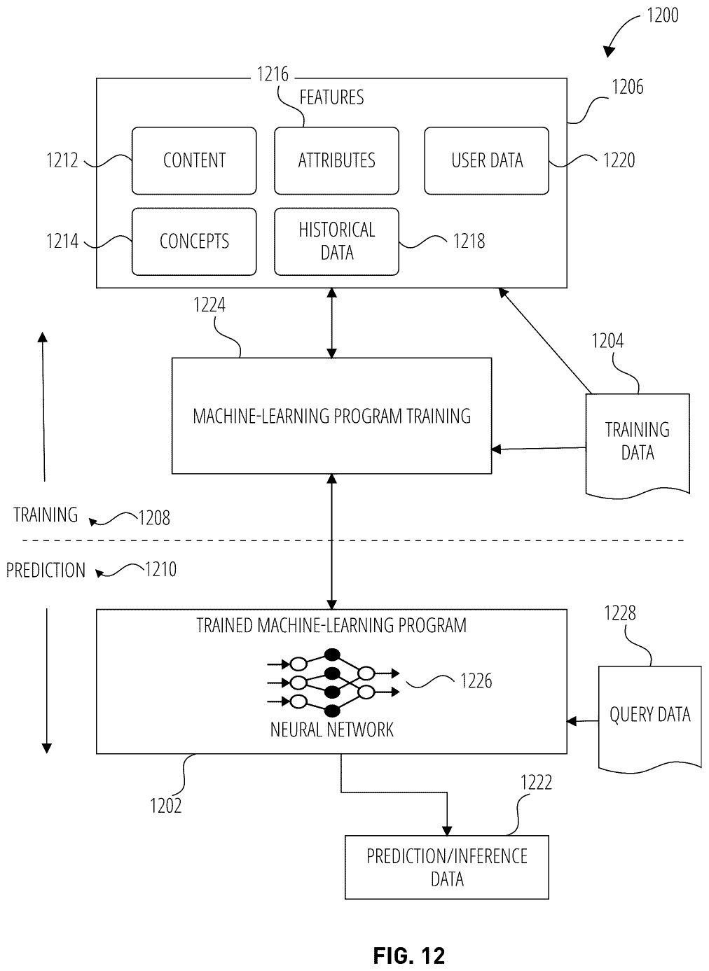

FIG. 12 is a flowchart depicting a machine-learning pipeline 1200, according to some examples. The machine-learning pipelines 1200 may be used to generate a trained model, for example the trained machine-learning program 1202 of FIG. 12, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

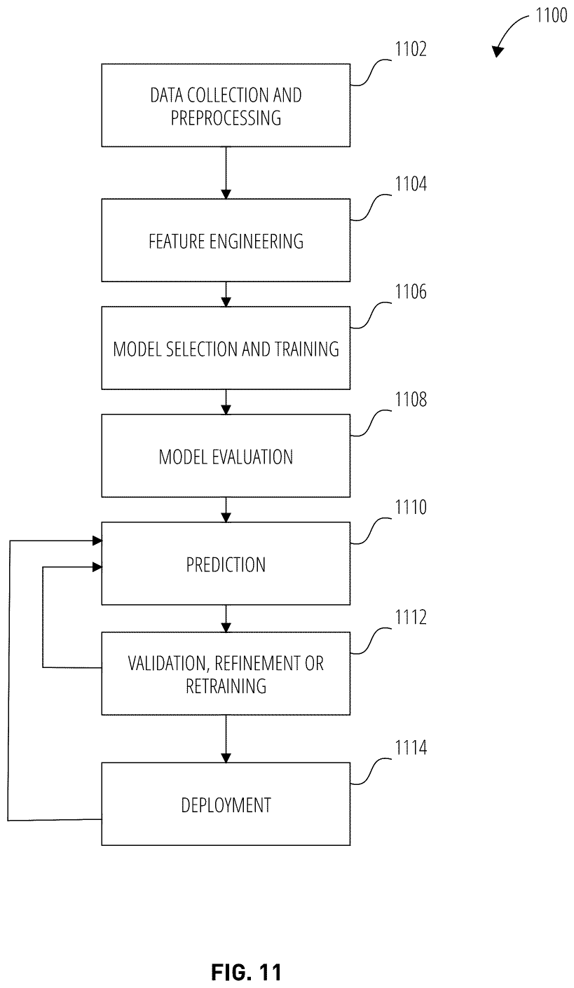

Generating a trained machine-learning program 1202 may include multiple types of phases that form part of the machine-learning pipeline 1200, including for example the following phases 1100 illustrated in FIG. 11:
Data collection and preprocessing 1102: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1104: This may include selecting and transforming the training data 1204 to create features that are useful for predicting the target variable. Feature engineering may include (1) receiving features 1206 (e.g., as structured or labeled data in supervised learning) and/or (2) identifying features 1206 (e.g., unstructured or unlabeled data for unsupervised learning) in training data 1204.
Model selection and training 1106: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1108: This may include evaluating the performance of a trained model (e.g., the trained machine-learning program 1202) on a separate testing dataset. This can help determine if the model is overfitting or underfitting and if it is suitable for deployment.
Prediction 1110: This involves using a trained model (e.g., trained machine-learning program 1202) to generate predictions on new, unseen data.
Validation, refinement or retraining 1112: This may include updating a model based on feedback generated from the prediction phase, such as new data or user feedback.
Deployment 1114: This may include integrating the trained model (e.g., the trained machine-learning program 1202) into a larger system or application, such as a web service, mobile app, or IoT device. This can involve setting up APIs, building a user interface, and ensuring that the model is scalable and can handle large volumes of data.

FIG. 12 illustrates two example phases, namely a training phase 1208 (part of the model selection and trainings 1106) and a prediction phase 1210 (part of prediction 1110). Prior to the training phase 1208, feature engineering 1104 is used to identify features 1206. This may include identifying informative, discriminating, and independent features for the effective operation of the trained machine-learning program 1202 in pattern recognition, classification, and regression. In some examples, the training data 1204 includes labeled data, which is known data for pre-identified features 1206 and one or more outcomes.

Each of the features 1206 may be a variable or attribute, such as individual measurable property of a process, article, system, or phenomenon represented by a data set (e.g., the training data 1204). Features 1206 may also be of different types, such as numeric features, strings, vectors, matrices, encodings, and graphs, and may include one or more of content 1212, concepts 1214, attributes 1216, historical data 1218 and/or user data 1220, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1208, the machine-learning pipeline 1200 uses the training data 1204 to find correlations among the features 1206 that affect a predicted outcome or prediction/inference data 1222.

With the training data 1204 and the identified features 1206, the trained machine-learning program 1202 is trained during the training phase 1208 during machine-learning program training 1224. The machine-learning program training 1224 appraises values of the features 1206 as they correlate to the training data 1204. The result of the training is the trained machine-learning program 1202 (e.g., a trained or learned model).

Further, the training phase 1208 may involve machine learning, in which the training data 1204 is structured (e.g., labeled during preprocessing operations), and the trained machine-learning program 1202 implements a relatively simple neural network 1226 capable of performing, for example, classification and clustering operations. In other examples, the training phase 1208 may involve deep learning, in which the training data 1204 is unstructured, and the trained machine-learning program 1202 implements a deep neural network 1226 that is able to perform both feature extraction and classification/clustering operations.

A neural network 1226 may, in some examples, be generated during the training phase 1208, and implemented within the trained machine-learning program 1202. The neural network 1226 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1226 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1226 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1208, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1226 is iteratively trained by adjusting model parameters to minimize a specific loss function or maximize a certain objective. The system can continue to train the neural network 1226 by adjusting parameters based on the output of the validation, refinement, or retraining block 1112, and rerun the prediction 1110 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1226 even after deployment 1114 of the neural network 1226. The neural network 1226 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1210, the trained machine-learning program 1202 uses the features 1206 for analyzing query data 1228 to generate inferences, outcomes, or predictions, as examples of a prediction/inference data 1222. For example, during prediction phase 1210, the trained machine-learning program 1202 is used to generate an output. Query data 1228 is provided as an input to the trained machine-learning program 1202, and the trained machine-learning program 1202 generates the prediction/inference data 1222 as output, responsive to receipt of the query data 1228. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1202 may be a generative AI model. Generative AI is a term that may refer to any type of artificial intelligence that can create new content from training data 1204. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1222 that is output include trend assessment and predictions, translations, summaries, image or video recognition and categorization, natural language processing, face recognition, user sentiment assessments, advertisement targeting and optimization, voice recognition, or media content generation, recommendation, and personalization.

### Usage Cases for Tokenization, Ownership, use, and/or the Like

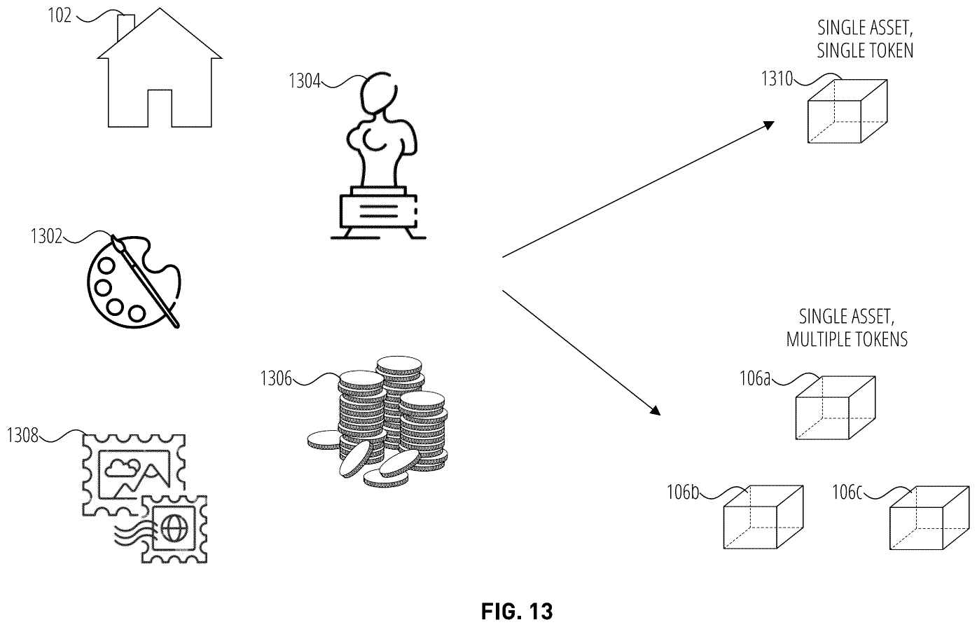

FIG. 13 illustrates tokenization of an asset as a whole, according to some examples. In some cases, a real world asset is not divided into parts by the tokenization system. For example, a home 102 is tokenized as a whole and not divided into different rooms. In some cases, the tokenization system tokenizes assets that are not easily dividable without changing the asset itself, such as a sculpture 1304, a painting 1302, a stamp in a stamp collection 1308, a coin in a rare coin collection 1306, and/or the like.

In some cases, the tokenization system generates and/or mints a single token 1310 corresponding to ownership or usage rights for the individual asset. In other cases, the tokenization system generates and/or mints multiple tokens 106a, 106b, 106c representing fractional ownership and/or different usage rights for the individual asset.

As users gain ownership and/or usage rights for the individual asset, users can start utilizing the asset as per the agreement and/or contractual terms (as further described herein).

In some cases, asset owners can jointly tokenize assets. For example, the artist and sculptor can jointly tokenize their paintings and sculptures. The joint assets can be tokenized either into a single token or multiple tokens. In some cases, the individual assets are valuated and tokens are assigned respectively. In other cases, a single token provides ownership and/or usage of the joint assets.

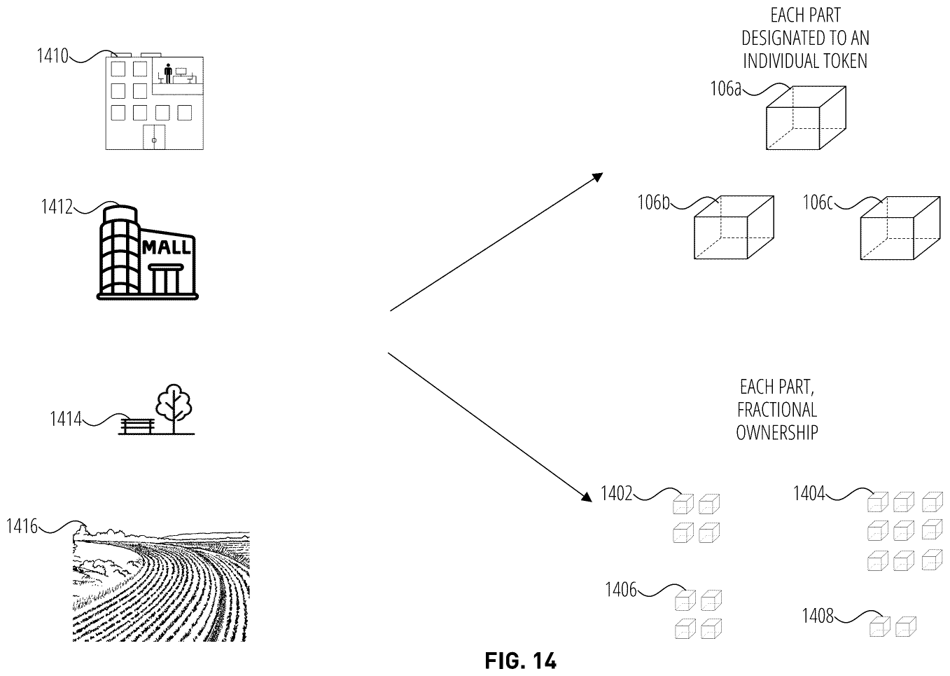

FIG. 14 illustrates tokenization of an asset that is divisible into parts, according to some examples. The tokenization system can divide an asset, such as a building 1410, a mall 1412, a park 1414, farm land 1416, into parts and tokenize individual parts for use and/or ownership. For example, a building can be divided into apartments, a mall can be divided into sections for stores, farm land divided into parcels, and/or the like.

In some cases, the tokenization system generates an individual usage and/or ownership token for each divisible part, such as token 106a for a first apartment unit, token 106b for a second apartment unit, and 106c for a third apartment unit. In other cases, the tokenization system generates multiple tokens for each part. such as tokens 1402 for a first store front, tokens 1404 for a second store front, tokens 1406 for a third store front, tokens 1408 for a fourth store front and/or the like. In some cases, the amount of tokens for each part is determined using the valuation methods and processes as further described herein.

In some cases, the tokenization system identifies divisible parts based on third party data, such as data on the number of units in an apartment building retrieved from a real estate or government website. In some cases, the tokenization system applies a machine learning model that is trained to automatically determine divisible portions of a particular asset. For example, the machine learning model can receive as input an address of an asset, a type of asset (such as if the asset type indicates a divisible number of parts such as a duplex), input from the asset owner of characteristics of the asset, and/or the like (other inputs to the machine learning model further described herein).

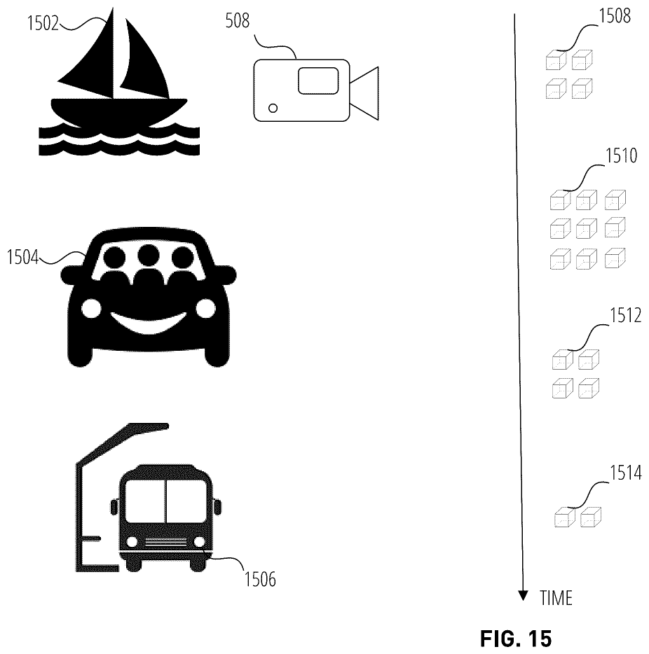

FIG. 15 illustrates tokenizing ownership and/or usage across time, according to some examples. In some cases, the tokenization system can tokenize an asset, such as a boat 1502, equipment 508, car 1504, public transportation 1506, and/or the like over time. The tokenization system applies ownership and/or usage rights over time. For example, a boat 1502 can be rented throughout the year for the use in boat tours.

The tokenization system can generate tokens according to the time and/or time frame desired for ownership and/or usage. For example, the tokenization system determines that boat tours are in demand in certain parts of the year but not in others. The tokenization system can apply the valuation methods and processes as further described herein to value the ownership and/or usage for particular time periods. For example, the time frame for tokens 1510 are in high demand, and thus more tokens are required for ownership and/or usage for these time slots, whereas the time periods for tokens 1508, 1512, and 1514 are in less demand and thus less tokens are minted for these time periods.

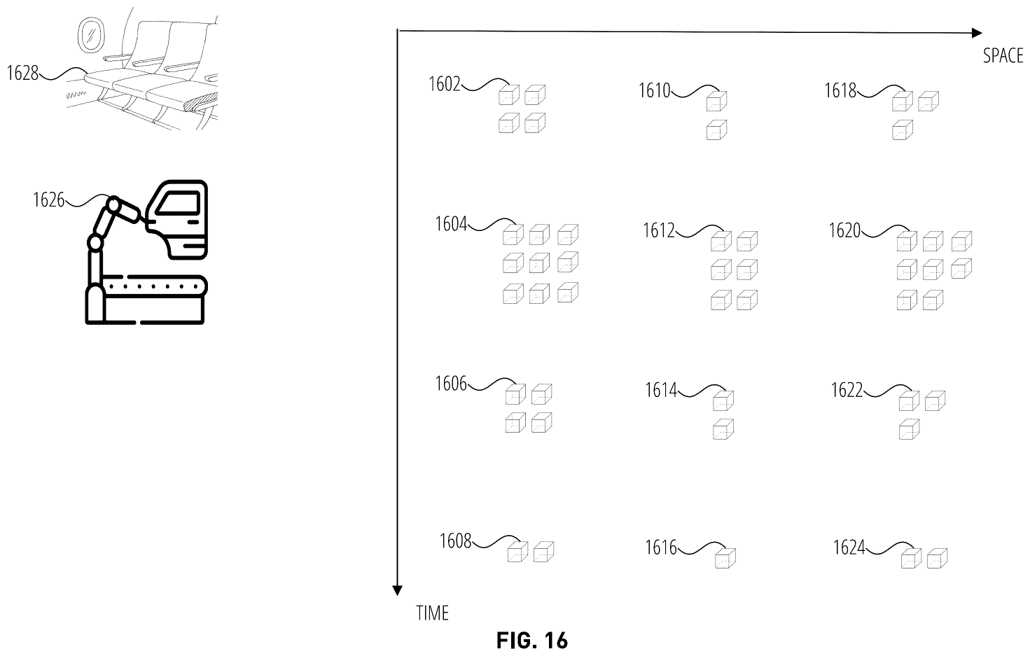

FIG. 16 illustrate tokenizing ownership and/or usage across time and parts, according to some examples. In some cases, the tokenization system tokenizes an asset across time and space. For example, the tokenization system divides an airplane 1628 into multiple seats or a multiple factory production lines in a factory 1626.

An airplane can have tens or hundreds of seats, each of which could be tokenized. In some cases, a group of seats can be tokenized, such as 4 seats for a family of 4. Such tokens can be tied to a particular airplane or to an airline with a fleet of airplanes.

In some cases, the tokenization system tokenizes ownership and/or usage across multiple factors, such as time and parts. It is appreciated that the tokenization system can tokenize an asset across one or more other factors, such as time and location, time parts and location, and/or the like.

As noted herein, the tokenization system can determine a valuation for the token based on these factors. In FIG. 16, the tokenization system determines that the certain seats at a particular time frame corresponding to tokens 1604 and 1620 are the highest in demand or highest in cost. As such, the more tokens are minted for the seats and time corresponding to tokens 1604 and 1620 than that for tokens 1602, 1610, 1618, 1612, 1606, 1614, 1622, 1608, 1616, and 1624.

In some cases, a factory with multiple production lines can tokenize each production line over different periods of time. Ownership of Tokens allow for the usage of associated production lines and collection of proceeds from the product line output. In some cases, a livestock production facility can tokenize each production line and across multiple cycles within a calendar year and offer those tokens to individual operators. These operators can make use of the facility for their own production and/or further offer the production line to other operators who could make use of the facility.

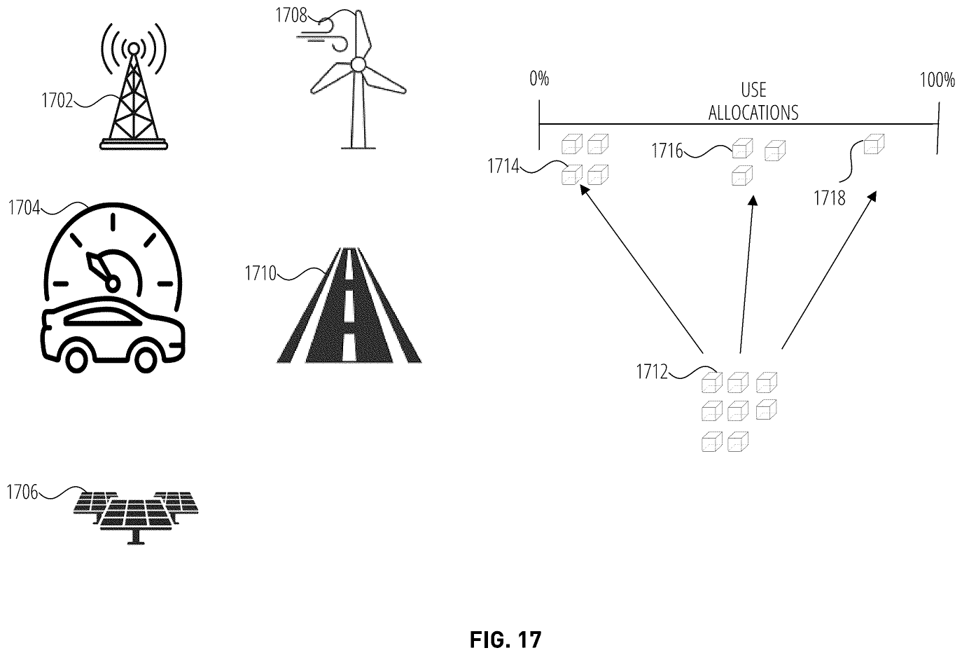

FIG. 17 illustrates tokenization for use allocations, according to some examples. The tokenization system can tokenize use allocations for assets. The tokenization system can tokenize cellphone towers 1702 such as based on data bandwidth usage. The tokenization system can tokenize amount of electricity generation by a wind turbine 1708 or solar farms 1706. The tokenization system can tokenize automobiles 1704 based on mileage. The tokenization system can tokenize use of roads 1710, such as an amount of traffic or length of travel.

Use allocations can be uniform across use, such as allocating the same amount of tokens for use of an automobile from 0-10 miles, 10-20 miles, 20-30 miles, etc. As shown in FIG. 17, use allocations can be different across use allocations. The automobile can be equivalent to a total token group 1712. However the use of the automobile may be of a higher value when the automobile is new. As such, the first group of miles for the automobile may be worth more tokens, such as tokens 1714, than when the automobile is at the middle of its lifespan, such as tokens 1716, or the end of its lifespan, such as token 1718.

In some cases, the tokenization system tokenizes cellphone towers (e.g., data use), automobile or farm equipment (e.g., mileage), oil wells, solar farms, wind turbines, other energy sources, mining rights, water rights, fishing quotas, bridges, toll roads, public transport, locations with services (e.g., fitness center, copy center, restaurant), and/or the like.

The tokenization system can tokenize an internet provider based on a provided bandwidth. The tokenization system can generate tokens representative of portions of bandwidth usage and provide such tokens to a large user base or virtual providers. The owners of these tokens can then use the associated bandwidth or sell the bandwidth to other users. A geographically diverse shared electricity grid can also tokenize its production of electricity and offer tokens to individual electricity producers that best meet the demands of their customers. Both these examples demonstrate the ability of the tokenization system to improve utilization of temporal assets that would be lost if not used immediately.

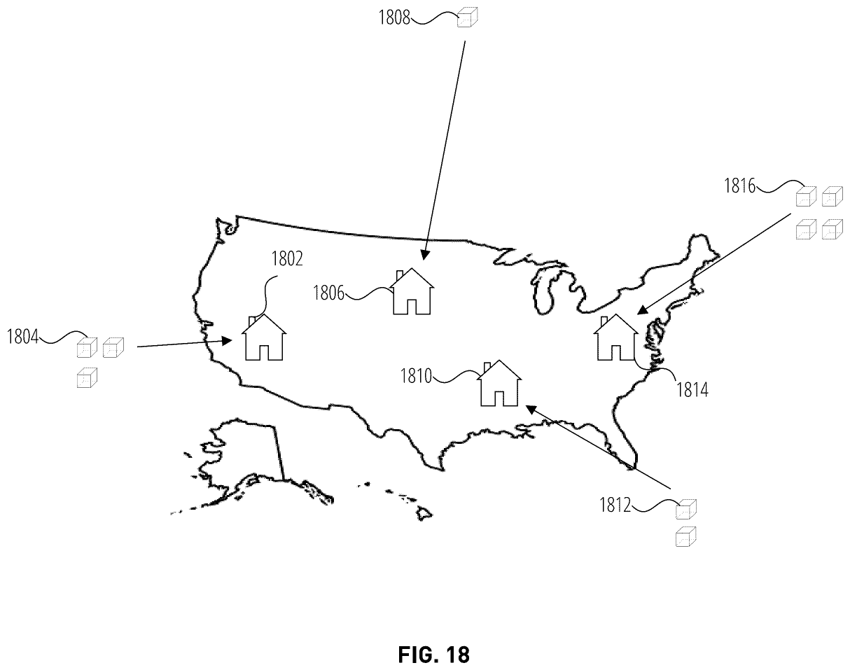

FIG. 18 illustrates token generation based on location, according to some examples. In some cases, the tokenization system tokenizes homes 1802, 1806, 1810, and 1814. Depending on the location of the home, the home may be valued differently. The tokenization system takes into consideration location, and/or other characteristics as described further herein in the valuation model, to determine a number of tokens to generate for the home. For example, home 1802 is provided with 3 tokens 1804, home 1806 is provided with 1 token 1808, home 1810 is provided with 2 tokens 1812, and home 1814 is provided with 4 tokens 1816.

In some cases, the tokenization system tokenizes medical facilities, clinics, wellness centers, companies (legal practices, accounting firms, consulting firms, research centers, etc.), and/or the like based on at least location.

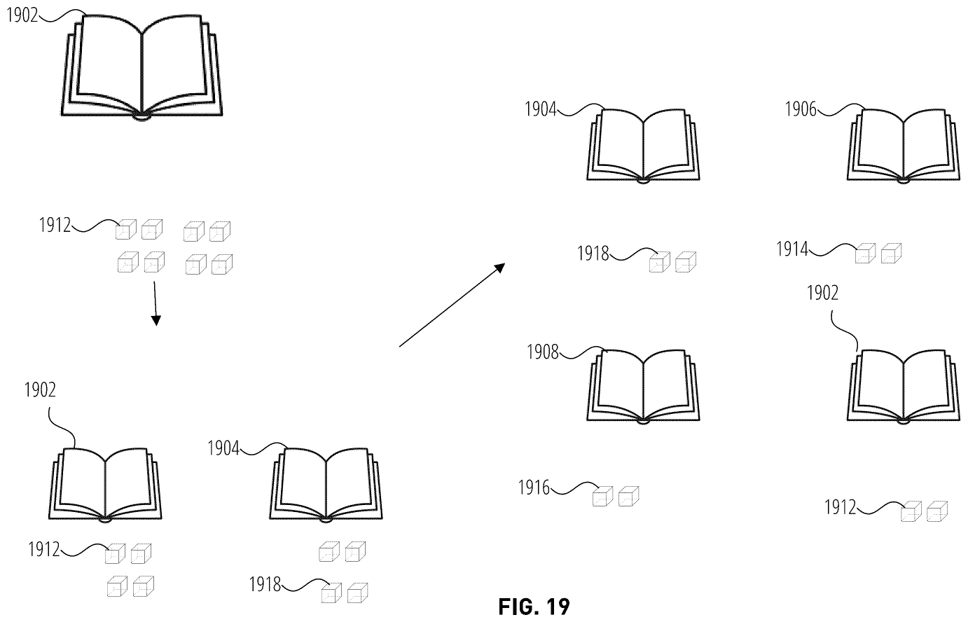

FIG. 19 illustrates token generation for copies of goods, according to some examples. In some cases, the tokenization system tokenizes copies of goods, such as artwork, creative works, books, movies, designs, architectural plans, educational content, music, software, formulas, recipes, advertisements, intellectual property, machine learning models, virtual objects (objects in virtual reality, augmented reality, mixed reality, etc), in-game items, in-application items, pharmaceuticals, and/or the like.

In some cases, as more copies are made, the more tokens are generated and/or the reduction of value for each token. For example, a book 1902 without any copies can be equivalent to 8 tokens 1912. The tokenization system can generate a first copy 1904 of the book and with the generated first copy, divide the number of tokens (e.g., 1912, 1914) equally between the original book 1902 and the first copy 1904. As such, the owner can decide how many copies to generate and how granular the owner desires the tokens and asset to be sold. In the next step, second copy 1906 and third copy 1908 are generated, and the tokenization system generates tokens 1918 and 1916 respectively. As shown in FIG. 19, after there are 4 copies in existence, the value for each book is reduced from 8 tokens down to 2 tokens each.

Although particular examples are described herein, such as a home being non-divisible and tokenized, it is appreciated that the example assets described herein can be applied to other types of tokenization. For example, the home 102 can be tokenized for usage across time, such as a short term rental.

The previous use cases can be combined whereby different features can be obtained from each case. This allows for a large amount of flexibility according to the underlying assets and intended usage. For example, the tokenization system can use the same tokens for different assets enabling flexibility in exchange of assets. For example, the tokenization system can apply tokens from a token owner issued by the same asset owner for use of different assets even if the assets are different or have different usage models.

Assets can be owned by a single or multiple asset owners. An asset owner can have a single or multiple assets. Assets can be used by a single or multiple tenants simultaneously. Asset usage can span a single or multiple time periods. A tenant may be allowed to utilize the asset for themselves only or offer it to be utilized by others. Intermediaries can borrow Tokens and acquire some asset ownership rights to offer the assets to other tenants. Asset utilization returns are shared with all token owners and potentially a portion of tenant returns. The asset itself can be made eligible for ownership if enough tokens are owned by a tenant.

As further described herein, the ownership and/or usage can be on a first come first serve basis, the tokenization system can implement a bidding auction whereby users can bid tokens and/or payments for a certain ownership or usage of an asset, and/or the like.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: receiving a first tangible asset ownership record for a tangible asset from a tangible asset custodian; identifying a value of the tangible asset; generating a plurality of asset-backed digital tokens corresponding to the value of the tangible asset based on the value and a value for each asset-backed digital tokens, each asset-backed digital tokens representing a fractional ownership interest in the tangible asset; transmitting the generated asset-backed digital tokens to a virtual digital token storage associated with the tangible asset custodian; receiving an indication of a first token disbursement from one or more tangible asset procurers; transmitting the asset-backed digital tokens corresponding to the first token disbursement from the virtual digital token storage associated with the tangible asset custodian to virtual digital token storages associated with the one or more tangible asset procurers reflecting updated ownership of the tangible asset; modifying the first tangible asset ownership record to reflect the updated ownership of the tangible asset; receiving from a tangible asset intermediary a request to temporarily receive all asset-backed digital tokens from the current owners of the tangible asset; transmitting all asset-backed digital tokens from the virtual digital token storages that hold the asset-backed digital tokens at a time of receiving the request to the virtual digital token storage of the tangible asset intermediary enabling usage rights of the tangible asset for the tangible asset intermediary; and periodically, during a first occupancy span for a tangible asset authorized user: receiving an indication of a second token disbursement from the tangible asset authorized user utilizing the tangible asset; and distributing portions of the second token disbursement to the virtual digital token storage of the tangible asset intermediary, the one or more tangible asset procurers, and the tangible asset custodian.

In Example 2, the subject matter of Example 1 includes, wherein the operations further comprise: transmitting all asset-backed digital tokens from the virtual digital token storage of the tangible asset intermediary to the virtual digital token storages that held the asset-backed digital tokens at a time of receiving the request, disabling usage rights of the tangible asset for the tangible asset intermediary.

In Example 3, the subject matter of Example 2 includes, wherein the operations further comprise: in response to transmitting all asset-backed digital tokens from the virtual digital token storage of the tangible asset intermediary to the virtual digital token storages that held the asset-backed digital tokens at the time of receiving the request, purging the asset-backed digital tokens corresponding from a circulating supply of asset-backed digital tokens.

In Example 4, the subject matter of Examples 1-3 includes, wherein the token disbursement includes the tangible asset authorized user submitting the token disbursement using asset-backed digital tokens stored in the virtual digital token storage of the tangible asset authorized user.

In Example 5, the subject matter of Examples 1-4 includes, wherein the operations further comprise: in response to a lapse of the first occupancy span for the tangible asset authorized user, renew the first occupancy span.

In Example 6, the subject matter of Examples 1-5 includes, wherein generating the plurality of asset-backed digital tokens comprises initiating generation of the plurality of asset-backed digital tokens by a group of nodes of a blockchain, wherein the operations further comprise: initiating recordation of the generation of the plurality of asset-backed digital tokens onto a distributed ledger of the blockchain, wherein the operations further comprise recording a transfer of the first tangible asset ownership record from the first tangible asset custodian to the system onto the distributed ledger.

In Example 7, the subject matter of Examples 1-6 includes, wherein the operations further comprise: performing optical character recognition (OCR) on the first tangible asset ownership record, and converting data identified from performing the OCR into a standardized format, identifying the value of the first tangible asset being based on the converted data.

In Example 8, the subject matter of Examples 1-7 includes, wherein the operations further comprise: providing the tangible asset authorized user with access to the first tangible asset by at least one of: generating a unique access code for a digital lock or security system of the first tangible asset, transmitting a signal to one or more Internet of Things (IoT) devices associated with the first tangible asset such that the one or more IoT devices grants access to the tangible asset authorized user, or automatically booking the first tangible asset for the tangible asset authorized user for the first occupancy span.

In Example 9, the subject matter of Examples 1-8 includes, wherein the first tangible asset includes a real estate property, the first tangible asset ownership record including a digitized deed, and the first tangible asset custodian including a real estate property owner.

In Example 10, the subject matter of Examples 1-9 includes, wherein the first occupancy span is for a lease agreement, the tangible asset authorized user including a tenant.

In Example 11, the subject matter of Examples 1-10 includes, wherein the first tangible asset includes a collection of physical assets, wherein the tangible asset authorized user is able to use one of the physical assets, wherein the tokens represent fractional ownership for the collection of the physical assets, wherein the value of the tokens required for the transfer of ownership is the value of the collection of the physical assets.

In Example 12, the subject matter of Examples 1-11 includes, wherein the operations further comprise: receiving a digital signature from the intermediary, the one or more tangible asset procurers, and the first tangible asset custodian prior to modifying the first tangible asset ownership record to reflect the updated ownership of the tangible asset.

In Example 13, the subject matter of Examples 1-12 includes, wherein the at least one processor is configured to apply the first tangible asset ownership record to a machine learning model, wherein the machine learning model perform the operations of identifying a value of the tangible asset, generating a plurality of asset-backed digital tokens corresponding to the value of the tangible asset based on the value and a value for each asset-backed digital tokens, each asset-backed digital tokens representing a fractional ownership interest in the tangible asset, and transmitting the generated asset-backed digital tokens to a virtual digital token storage associated with the tangible asset custodian.

In Example 14, the subject matter of Examples 1-13 includes, wherein the at least one processor is configured to apply the first token disbursement to a machine learning model, wherein the machine learning model perform the operations of transmitting the asset-backed digital tokens corresponding to the first token disbursement from the virtual digital token storage associated with the tangible asset custodian to virtual digital token storages associated with the one or more tangible asset procurers reflecting updated ownership of the tangible asset and modifying the first tangible asset ownership record to reflect the updated ownership of the tangible asset.

In Example 15, the subject matter of Examples 1-14 includes, wherein the at least one processor is configured to apply the request to a machine learning model, wherein the machine learning model performs the operations of transmitting all asset-backed digital tokens from the virtual digital token storages that hold the asset-backed digital tokens at a time of receiving the request to the virtual digital token storage of the tangible asset intermediary enabling usage rights of the tangible asset for the tangible asset intermediary.

Example 16 is a method comprising: receiving a first tangible asset ownership record for a tangible asset from a tangible asset custodian; identifying a value of the tangible asset; generating a plurality of asset-backed digital tokens corresponding to the value of the tangible asset based on the value and a value for each asset-backed digital tokens, each asset-backed digital tokens representing a fractional ownership interest in the tangible asset; transmitting the generated asset-backed digital tokens to a virtual digital token storage associated with the tangible asset custodian; receiving an indication of a first token disbursement from one or more tangible asset procurers; transmitting the asset-backed digital tokens corresponding to the first token disbursement from the virtual digital token storage associated with the tangible asset custodian to virtual digital token storages associated with the one or more tangible asset procurers reflecting updated ownership of the tangible asset; modifying the first tangible asset ownership record to reflect the updated ownership of the tangible asset; receiving from a tangible asset intermediary a request to temporarily receive all asset-backed digital tokens from the current owners of the tangible asset; transmitting all asset-backed digital tokens from the virtual digital token storages that hold the asset-backed digital tokens at a time of receiving the request to the virtual digital token storage of the tangible asset intermediary enabling usage rights of the tangible asset for the tangible asset intermediary; periodically, during a first occupancy span for a tangible asset authorized user: receiving an indication of a second token disbursement from the tangible asset authorized user utilizing the tangible asset; and distributing portions of the second token disbursement to the virtual digital token storage of the tangible asset intermediary, the one or more tangible asset procurers, and the tangible asset custodian; and transmitting all asset-backed digital tokens from the virtual digital token storage of the tangible asset intermediary to the virtual digital token storages that held the asset-backed digital tokens at a time of receiving the request, disabling usage rights of the tangible asset for the tangible asset intermediary.

Example 17 is a non-transitory computer-readable storage medium storing instructions that, when executed by at least one processor, cause the at least one processor to perform operations comprising: receiving a first tangible asset ownership record for a tangible asset from a tangible asset custodian; identifying a value of the tangible asset; generating a plurality of asset-backed digital tokens corresponding to the value of the tangible asset based on the value and a value for each asset-backed digital tokens, each asset-backed digital tokens representing a fractional ownership interest in the tangible asset; transmitting the generated asset-backed digital tokens to a virtual digital token storage associated with the tangible asset custodian; receiving an indication of a first token disbursement from one or more tangible asset procurers; transmitting the asset-backed digital tokens corresponding to the first token disbursement from the virtual digital token storage associated with the tangible asset custodian to virtual digital token storages associated with the one or more tangible asset procurers reflecting updated ownership of the tangible asset; modifying the first tangible asset ownership record to reflect the updated ownership of the tangible asset; receiving from a tangible asset intermediary a request to temporarily receive all asset-backed digital tokens from the current owners of the tangible asset; transmitting all asset-backed digital tokens from the virtual digital token storages that hold the asset-backed digital tokens at a time of receiving the request to the virtual digital token storage of the tangible asset intermediary enabling usage rights of the tangible asset for the tangible asset intermediary; periodically, during a first occupancy span for a tangible asset authorized user: receiving an indication of a second token disbursement from the tangible asset authorized user utilizing the tangible asset; and distributing portions of the second token disbursement to the virtual digital token storage of the tangible asset intermediary, the one or more tangible asset procurers, and the tangible asset custodian; and transmitting all asset-backed digital tokens from the virtual digital token storage of the tangible asset intermediary to the virtual digital token storages that held the asset-backed digital tokens at a time of receiving the request, disabling usage rights of the tangible asset for the tangible asset intermediary.

Example 18 is at least one machine-readable medium including instructions that, when executed by processing circuitry, cause the processing circuitry to perform operations to implement any of Examples 1-17.

Example 19 is an apparatus comprising means to implement any of Examples 1-17.

Example 20 is a system to implement any of Examples 1-17.

Example 21 is a method to implement any of Examples 1-17.

Although examples described herein describe features of the tokenization system using a digitized asset rights document, it is appreciated that the features of the tokenization system can apply to other forms, such as real world property ownership certificate, digital physical property title, digitized asset rights, document, physical asset registry record, physical commodity ownership record document, real estate ownership certificate, real estate possession record, tangible asset ownership record, tangible property conveyance document, deed, title, and/or the like, and/or vice versa.

Although examples described herein describe features of the tokenization system using a real world asset, it is appreciated that the features of the tokenization system can apply to other forms, such as real world property, physical property, tangible property, physical commodity, real estate property, physical asset, real estate, tangible asset, real world asset, and/or the like, and/or vice versa.

Although examples described herein describe features of the tokenization system using an asset holder, it is appreciated that the features of the tokenization system can apply to other forms, such as real world property owner, physical property owner, tangible property owner, physical commodity holder, real estate property proprietor, physical asset possessor, real estate possessor, tangible asset custodian, and/or the like, and/or vice versa.

Although examples described herein describe features of the tokenization system using an asset utilizer, it is appreciated that the features of the tokenization system can apply to other forms, such as real world property user, physical property user, tangible property occupant, physical commodity occupier, real estate property utilizer, physical asset acquirer, real estate user, tangible asset renter, and/or the like, and/or vice versa.

Although examples described herein describe features of the tokenization system using a physical commodity acquirer, it is appreciated that the features of the tokenization system can apply to other forms, such as real estate recipient, tangible asset procurer, and/or the like, and/or vice versa.

Although examples described herein describe features of the tokenization system using a digital tokens, it is appreciated that the features of the tokenization system can apply to other forms, such as digital rights tokens, virtual asset units, electronic ownership tokens, fractionalized property token, digital real estate property token, physical asset digital ledger coins, asset-backed tokens, and/or the like, and/or vice versa.

Although examples described herein describe features of the tokenization system using a digital wallet, it is appreciated that the features of the tokenization system can apply to other forms, such as digital rights token storage, virtual asset storage, electronic token data repository, tokenized account, digital Token repository, digital ledger wallet, digital token storage, virtual token storage, and/or the like, and/or vice versa.

Although examples described herein describe features of the tokenization system using an asset transaction, it is appreciated that the features of the tokenization system can apply to other forms, such as remittance, virtual asset relocation, tokenized exchange, token resource allocation, token provision, digital ledger coin transfer, digital token relocation, token disbursement, asset transaction, digital token relocation, and/or the like, and/or vice versa. Moreover, the tokens in the token disbursement, relocation, remittance, exchange, provisions and/or the like described herein can be different tokens than the tokens that represent usage rights or ownership rights.

Although examples described herein describe features of the tokenization system using an asset utilization period, it is appreciated that the features of the tokenization system can apply to other forms, such as real world property use term, physical property utilization period, occupancy span, tokenized tenure, physical asset use duration, real estate utilization period, and/or the like, and/or vice versa.

### Conclusion

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
receiving a first tangible asset ownership record for a tangible asset from a tangible asset custodian;
identifying a value of the tangible asset;
generating a plurality of asset-backed digital tokens corresponding to the value of the tangible asset based on the value and a value for each asset-backed digital tokens, each asset-backed digital tokens representing a fractional ownership interest in the tangible asset;
transmitting the generated asset-backed digital tokens to a virtual digital token storage associated with the tangible asset custodian;
receiving an indication of a first token disbursement from one or more tangible asset procurers;
transmitting the asset-backed digital tokens corresponding to the first token disbursement from the virtual digital token storage associated with the tangible asset custodian to virtual digital token storages associated with the one or more tangible asset procurers reflecting updated ownership of the tangible asset;
modifying the first tangible asset ownership record to reflect the updated ownership of the tangible asset;
receiving from a tangible asset intermediary a request to temporarily receive all asset-backed digital tokens from current owners of the tangible asset;
transmitting all asset-backed digital tokens from the virtual digital token storages that hold the asset-backed digital tokens at a time of receiving the request to the virtual digital token storage of the tangible asset intermediary enabling usage rights of the tangible asset for the tangible asset intermediary; and
periodically, during a first occupancy span for a tangible asset authorized user:
receiving an indication of a second token disbursement from the tangible asset authorized user utilizing the tangible asset; and
distributing portions of the second token disbursement to the virtual digital token storage of the tangible asset intermediary, the one or more tangible asset procurers, and the tangible asset custodian.

2. The system of claim 1, wherein the operations further comprise: transmitting all asset-backed digital tokens from the virtual digital token storage of the tangible asset intermediary to the virtual digital token storages that held the asset-backed digital tokens at a time of receiving the request, disabling usage rights of the tangible asset for the tangible asset intermediary.

3. The system of claim 2, wherein the operations further comprise: in response to transmitting all asset-backed digital tokens from the virtual digital token storage of the tangible asset intermediary to the virtual digital token storages that held the asset-backed digital tokens at the time of receiving the request, purging the asset-backed digital tokens corresponding from a circulating supply of asset-backed digital tokens.

4. The system of claim 1, wherein the second token disbursement includes the tangible asset authorized user submitting the second token disbursement using asset-backed digital tokens stored in the virtual digital token storage of the tangible asset authorized user.

5. The system of claim 1, wherein the operations further comprise:
in response to a lapse of the first occupancy span for the tangible asset authorized user, renew the first occupancy span.

6. The system of claim 1, wherein generating the plurality of asset-backed digital tokens comprises initiating generation of the plurality of asset-backed digital tokens by a group of nodes of a blockchain, wherein the operations further comprise: initiating recordation of the generation of the plurality of asset-backed digital tokens onto a distributed ledger of the blockchain, wherein the operations further comprise recording a transfer of the first tangible asset ownership record from the tangible asset custodian to the system onto the distributed ledger.

7. The system of claim 1, wherein the operations further comprise: performing optical character recognition (OCR) on the first tangible asset ownership record, and converting data identified from performing the OCR into a standardized format, identifying the value of the tangible asset being based on the converted data.

8. The system of claim 1, wherein the operations further comprise: providing the tangible asset authorized user with access to the tangible asset by at least one of: generating a unique access code for a digital lock or security system of the tangible asset, transmitting a signal to one or more Internet of Things (IoT) devices associated with the tangible asset such that the one or more IoT devices grants access to the tangible asset authorized user, or automatically booking the tangible asset for the tangible asset authorized user for the first occupancy span.

9. The system of claim 1, wherein the tangible asset includes a real estate property, the first tangible asset ownership record including a digitized deed, and the tangible asset custodian including a real estate property owner.

10. The system of claim 1, wherein the first occupancy span is for a lease agreement, the tangible asset authorized user including a tenant.

11. The system of claim 1, wherein the tangible asset includes a collection of physical assets, wherein the tangible asset authorized user is able to use one of the physical assets, wherein the tokens represent fractional ownership for the collection of the physical assets, wherein the value of the tokens required for the transfer of ownership is the value of the collection of the physical assets.

12. The system of claim 1, wherein the operations further comprise: receiving a digital signature from the intermediary, the one or more tangible asset procurers, and the tangible asset custodian prior to modifying the first tangible asset ownership record to reflect the updated ownership of the tangible asset.

13. The system of claim 1, wherein the at least one processor is configured to apply the first tangible asset ownership record to a machine learning model, wherein the machine learning model perform the operations of identifying a value of the tangible asset, generating a plurality of asset-backed digital tokens corresponding to the value of the tangible asset based on the value and a value for each asset-backed digital tokens, each asset-backed digital tokens representing a fractional ownership interest in the tangible asset, and transmitting the generated asset-backed digital tokens to a virtual digital token storage associated with the tangible asset custodian.

14. The system of claim 1, wherein the at least one processor is configured to apply the first token disbursement to a machine learning model, wherein the machine learning model perform the operations of transmitting the asset-backed digital tokens corresponding to the first token disbursement from the virtual digital token storage associated with the tangible asset custodian to virtual digital token storages associated with the one or more tangible asset procurers reflecting updated ownership of the tangible asset and modifying the first tangible asset ownership record to reflect the updated ownership of the tangible asset.

15. The system of claim 1, wherein the at least one processor is configured to apply the request to a machine learning model, wherein the machine learning model performs the operations of transmitting all asset-backed digital tokens from the virtual digital token storages that hold the asset-backed digital tokens at a time of receiving the request to the virtual digital token storage of the tangible asset intermediary enabling usage rights of the tangible asset for the tangible asset intermediary.

16. A method comprising:
receiving a first tangible asset ownership record for a tangible asset from a tangible asset custodian;
identifying a value of the tangible asset;
generating a plurality of asset-backed digital tokens corresponding to the value of the tangible asset based on the value and a value for each asset-backed digital tokens, each asset-backed digital tokens representing a fractional ownership interest in the tangible asset;
transmitting the generated asset-backed digital tokens to a virtual digital token storage associated with the tangible asset custodian;
receiving an indication of a first token disbursement from one or more tangible asset procurers;
transmitting the asset-backed digital tokens corresponding to the first token disbursement from the virtual digital token storage associated with the tangible asset custodian to virtual digital token storages associated with the one or more tangible asset procurers reflecting updated ownership of the tangible asset;
modifying the first tangible asset ownership record to reflect the updated ownership of the tangible asset;
receiving from a tangible asset intermediary a request to temporarily receive all asset-backed digital tokens from current owners of the tangible asset;
transmitting all asset-backed digital tokens from the virtual digital token storages that hold the asset-backed digital tokens at a time of receiving the request to the virtual digital token storage of the tangible asset intermediary enabling usage rights of the tangible asset for the tangible asset intermediary;
periodically, during a first occupancy span for a tangible asset authorized user:
receiving an indication of a second token disbursement from the tangible asset authorized user utilizing the tangible asset; and
distributing portions of the second token disbursement to the virtual digital token storage of the tangible asset intermediary, the one or more tangible asset procurers, and the tangible asset custodian; and
transmitting all asset-backed digital tokens from the virtual digital token storage of the tangible asset intermediary to the virtual digital token storages that held the asset-backed digital tokens at a time of receiving the request, disabling usage rights of the tangible asset for the tangible asset intermediary.

17. A non-transitory computer-readable storage medium storing instructions that, when executed by at least one processor, cause the at least one processor to perform operations comprising:
receiving a first tangible asset ownership record for a tangible asset from a tangible asset custodian;
identifying a value of the tangible asset;
generating a plurality of asset-backed digital tokens corresponding to the value of the tangible asset based on the value and a value for each asset-backed digital tokens, each asset-backed digital tokens representing a fractional ownership interest in the tangible asset;
transmitting the generated asset-backed digital tokens to a virtual digital token storage associated with the tangible asset custodian;
receiving an indication of a first token disbursement from one or more tangible asset procurers;
transmitting the asset-backed digital tokens corresponding to the first token disbursement from the virtual digital token storage associated with the tangible asset custodian to virtual digital token storages associated with the one or more tangible asset procurers reflecting updated ownership of the tangible asset;
modifying the first tangible asset ownership record to reflect the updated ownership of the tangible asset;
receiving from a tangible asset intermediary a request to temporarily receive all asset-backed digital tokens from current owners of the tangible asset;
transmitting all asset-backed digital tokens from the virtual digital token storages that hold the asset-backed digital tokens at a time of receiving the request to the virtual digital token storage of the tangible asset intermediary enabling usage rights of the tangible asset for the tangible asset intermediary;
periodically, during a first occupancy span for a tangible asset authorized user:
receiving an indication of a second token disbursement from the tangible asset authorized user utilizing the tangible asset; and
distributing portions of the second token disbursement to the virtual digital token storage of the tangible asset intermediary, the one or more tangible asset procurers, and the tangible asset custodian; and
transmitting all asset-backed digital tokens from the virtual digital token storage of the tangible asset intermediary to the virtual digital token storages that held the asset-backed digital tokens at a time of receiving the request, disabling usage rights of the tangible asset for the tangible asset intermediary.
